(19) United States
(12) Patent Application Publication
(10) Pub. No.: US 2026/0195447 A1
(43) Pub. Date: Jul. 9, 2026

(54) ATTACK SURFACE TAGGING USING USER-CONFIGURED TAG SPECIFICATIONS

(71) Applicant: Cisco Technology, Inc., San Jose, CA (US)

(72) Inventors: Ian Allison, Carlsbad, CA (US); Christopher Walter O’Neil, San Marcos, CA (US)

(73) Assignee: Cisco Technology, Inc., San Jose, CA (US)

(21) Appl. No.: 19/014,048

(22) Filed: Jan. 8, 2025

(51) Int. Cl. G06F 21/55

(52) U.S. Cl. CPC G06F 21/554; G06F 2221/034

(57) ABSTRACT

Techniques for automated attack surface target tagging using user-configured tag specifications are described. An attack surface management (ASM) system tags attack surface targets via use of user-configured tag specifications. The user-configured tag specifications can provide a tag and zero, one, or more conditions to be evaluated to determine whether the tag, and any optionally indicated associated tags, are to be associated with a target. The tag specification can be provided via straightforward graphical user interfaces or in a human-readable data serialization language.

### RELATED APPLICATIONS

Any and all applications for which a foreign or domestic priority claim is identified in the Application Data Sheet as filed with the present application are incorporated by reference under 37 CFR 1.57 and made a part of this specification.

### BACKGROUND

Attack Surface Management (ASM) is an important aspect of cybersecurity. ASM involves the continuous discovery, analysis, prioritization, remediation, and monitoring of vulnerabilities and potential attack vectors within an organization's information technology (IT) infrastructure. Unlike traditional cybersecurity measures, ASM approaches threat detection and vulnerability management from the perspective of an attacker, which helps in identifying and mitigating risks more effectively. ASM is often viewed as essential for maintaining a proactive security posture, especially in today's dynamic IT environments where new vulnerabilities can emerge rapidly.

ASM systems typically utilize a continuous discovery approach, where the systems continuously identify assets, both known and unknown, that could be potential entry points for cyberattacks. These assets, also referred to as computing resources, can include on-premises assets, cloud assets, external services, subsidiary networks, etc. After these assets are identified, some ASM systems analyze them for vulnerabilities. These vulnerabilities are then prioritized based on the risk they pose to the organization. The ASM, or associated systems and/or security professionals, can take steps to remediate these vulnerabilities and continue monitoring the attack surface for new vulnerabilities. For example, ASM solutions often integrate with other security tools like Security Information and Event Management (SIEM) systems, Endpoint Detection and Response (EDR) systems, and/or Extended Detection and Response (XDR) systems to enhance threat mitigation and response.

### BRIEF DESCRIPTION OF THE DRAWINGS

Illustrative examples are described in detail below with reference to the following figures:

FIG. 1 is a diagram of an example computing environment for automated attack surface target tagging using user-configured tag specifications according to some examples.

FIG. 2 illustrates an attack surface management system implementing automated attack surface target tagging using user-configured tag specifications in an environment as part of an IT and security operations application according to some examples.

FIG. 3 illustrates example computing components and operations of an attack surface management system for automated attack surface target tagging using user-configured tag specifications according to some examples.

FIG. 4 illustrates an example tag specification and attack surface data that can be used for automated attack surface target tagging by an attack surface management system according to some examples.

FIG. 5 illustrates an example graphical user interface for obtaining user input for creating user-configured tag specifications according to some examples.

FIG. 6 illustrates other portions of an example graphical user interface for obtaining user input for creating user-configured tag specifications according to some examples.

FIG. 7 illustrates an example graphical user interface for target exploration with tag visibility and filtering according to some examples.

FIG. 8 is a flowchart illustrating operations of an example process for automated attack surface target tagging using user-configured tag specifications according to some examples.

FIG. 9 is a block diagram illustrating an example computing environment that includes a data intake and query system according to some examples.

FIG. 10 is a block diagram illustrating in greater detail an example of an indexing system of a data intake and query system according to some examples.

FIG. 11 is a block diagram illustrating in greater detail an example of the search system of a data intake and query system according to some examples.

### DETAILED DESCRIPTION

Organizations often have a large IT footprint due to a combination of diverse infrastructure, global operations, and digital transformation initiatives. This includes managing a mix of on-premises data centers, cloud services, and hybrid environments, as well as supporting a global workforce with regional data centers and communication networks. The adoption of new technologies, such as IoT devices and mobile applications, further expands the IT landscape.

Additionally, mergers and acquisitions contribute to a larger IT footprint by integrating the systems and assets of acquired companies. The rise of remote work and bring-your-own-device (BYOD) policies means that employees may use personal devices to access corporate networks, increasing the number of endpoints that need to be secured. Third-party services and vendor relationships also add to the complexity, introducing additional IT assets and potential vulnerabilities.

To manage this extensive IT environment, organizations need robust strategies for asset management, security, and continuous monitoring. This involves identifying and securing all components, integrating different systems, and addressing various challenges to ensure optimal functionality and security. Effective management of a large IT footprint is essential for maintaining a proactive security posture and supporting the organization's operations.

As a part of this management, organizations may employ an ASM system to continuously monitor their IT environments. Organizations may potentially use off-the-shelf ASM systems provided by vendors, though these can be “rigid” in that they cannot be extended or customized based on a particular organization's needs. Alternatively, an organization may create their own ASM system, though this is an enormously complex task requiring continued support and revision as technologies change and the organization's use of technology changes.

One major issue with ASM systems involves how users and processes can interact with the knowledge base of computing resources (or “targets” of a mapped attack surface) that it discovers, such as administrative interfaces, application programming interfaces (APIs), authentication entry points, data, data pathways, databases, storage devices and systems, user interfaces, physical computing devices, physical or logical ports, network devices, web applications, websites, directories, operating systems, accounts, or the like. For example, ASM systems may track hundreds, thousands, or many more targets, which can overload the organization via information overload, as users or systems need to be able to “drill down” to quickly identify issues or targets of interest. Additionally, this data needs to somehow be consumable by automated processes so that they can automatically identify particular targets in order to be able to act in some manner, such as through notifying administrators of issues, launching investigative processes or security responses, or the like.

To this end, some systems utilize tagging to assist in organizing targets. Often, users manually assign tags, typically alphanumeric strings, to various targets tracked in the ASM system. For example, an identifier of a target (or computing resource) is associated with an identifier of a tag (e.g., a string value) in a data structure such as a database, allowing a user or system to quickly be able to find any or all such targets associated with a particular tag. Initially, these systems may have no tags, requiring users to create and thereafter associate them as needed. This process can become overwhelming due to the large number of computing resources and the near-continuous addition of new assets, devices, operating systems, users, services, applications, and protocols.

To assist in this process, an ASM system may be designed to attempt to automatically assign particular tags to particular targets. To do this, software engineers typically need to determine that a particular tag is needed, when to associate that particular tag with a particular type of target, and then determine how to do that in a programmatic manner. Then, the engineers must update the codebase of the ASM system to be able to perform these operations, verify that the new logic is correct, and update the ASM system code accordingly. This is a tremendously slow and involved process, and typically results in erroneous tagging where improper targets are associated with a tag and/or targets that should be so associated are not. Accordingly, it is very difficult, especially in larger organizations, to be able to add a new type of tag into use, modify a tag or its logic, or allow new users to be able to install such tags into the system.

The present disclosure relates to methods, apparatus, systems, and non-transitory computer-readable storage media for automated attack surface target tagging using user-configured tag specifications. In some examples, users can provide or specify tag specifications that define a tag and how it is to be applied to targets by the ASM system. The tag specifications can provide a comparatively easy way for users to define them, while retaining the ability for the ASM system to use them in an automated manner. In some examples, a tag specification is crafted using an attack surface serialization language, which can be based on a human-readable data format such as YAML or JSON (JavaScript Object Notation), enabling users to easily create, understand, and update the tag specifications while still being able to be operated upon by automated software. By treating tag specifications as configuration type data, this tag-specific logic and configuration is separated from the central code of the ASM system itself, allowing the definition and use of tags to be simply updated and applied by a variety of users without needing to modify the ASM system code itself. In some examples, users can manually define such a tag specification directly using a text-type editor, and in some examples, define the tag specification using a graphical user interface, allowing further ease of use by newcomers and experts alike.

Accordingly, ASM systems disclosed herein can be quickly updated to support new tags, allowing for improved security of the entire IT environment that it is monitoring and analyzing. As one example, upon detecting a new type of security vulnerability that may apply to a particular type of device, operating system, protocol, or the like, a new tag can be quickly and confidently generated and used to immediately discover targets within the attack surface that may be affected - in many cases without requiring further scanning or investigation. Thus, security analysts can immediately determine which targets are currently affected by the vulnerability or may have been affected by the vulnerability, such as at previous points in time when a target was in use though may no longer be in use. This allows rapid and appropriate responses to such threats to be implemented, including automated or semi-automated remediative actions such as sending alert notifications or other messages, generating a report, performing additional reconnaissance, creating support tickets (e.g., adding a job task to a queue), configuring networking equipment or computing systems to block certain types of network traffic, isolating or shutting down systems, enabling enhanced network monitoring or protections, or the like.

Moreover, examples disclosed herein can enable for tag specifications to be validated, including any logical conditions defined therein that indicate how to apply a tag to a target, to ensure their correctness prior to inclusion in a production ASM system. For example, the tag specification may be configured with known targets and/or known non-targets reflective of targets that should have the tag associated and targets that should not. Accordingly, the ASM system can ensure that any provided known targets are identified by the defined logic, while any provided known non-targets are not identified by the defined logic, and can immediately notify an operator of an issue if these checks fail, prevent the tag specification from used or “accepted” into the system, etc.

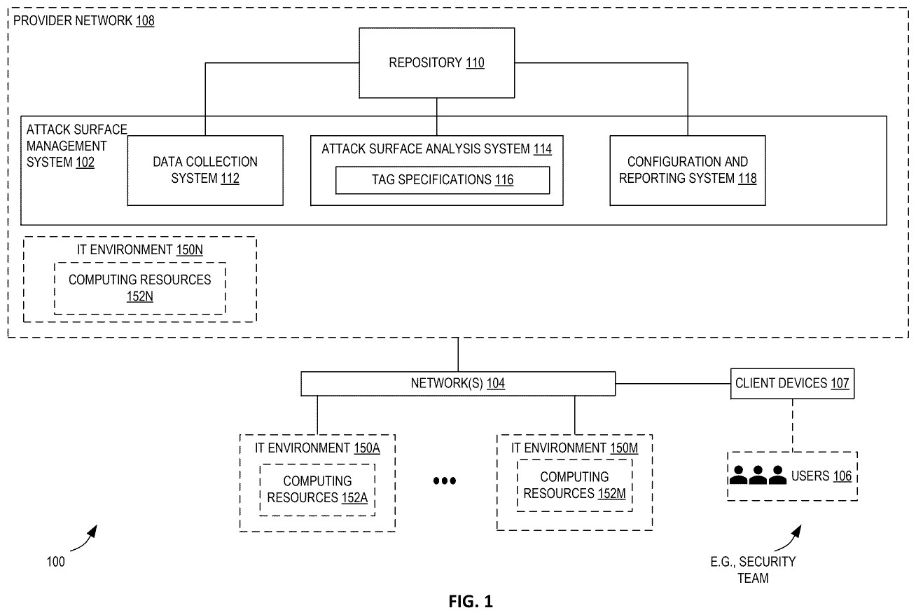

FIG. 1 is a diagram of an example computing environment 100 for automated attack surface target tagging using user-configured tag specifications according to some examples. As shown, an attack surface management system 102 can utilize user-configured tag specifications 116 to automatically perform target tagging. The attack surface management system 102 in FIG. 1 includes a data collection system 112 for collecting and organizing target metadata from one or more IT environments 150A-150M, an attack surface analysis system 114 for performing tagging of targets based on tag specifications 116, and a configuration and reporting system 118 for obtaining configuration information from users and/or providing outputs or results from processing to other users and/or systems, e.g., via implementing interfaces such as application programming interfaces (APIs) or the like. As shown later herein, some or all of these components can be part of an IT and security operations application. In various examples, these components can be implemented as software executed by one or multiple computing devices at one or multiple locations. For example, some or all of these attack surface management system 102 components may be implemented within a provider network 108 (e.g., in a public “cloud” provider network or another private network) and its functionality utilized by other users (e.g., via client devices 107) across one or more networks 104. For example, an attack surface analysis system 114 can be implemented in various locations at the edge of the internet, e.g., with direct access to IPv4 and/or IPv6 network stacks. As another example, some or all of these attack surface management system 102 components may be implemented within a customer's network (e.g., within one or more premises operated by an organization), such as by deploying them via use of one or more servers located in an “on-prem” network (e.g., in an IT environment 150A). In other examples, some components may be deployed in a customer's network while other components can be deployed separately (e.g., in a cloud provider network 108).

Entities of various types, such as companies, educational institutions, medical facilities, governmental departments, and private individuals, among other examples, operate computing environments for various purposes. Computing environments, which can also be referred to as IT environments 150, can include inter-networked, physical hardware devices, the software executing on the hardware devices, and/or the users of the hardware and software. As an example, an entity such as a school can operate a Local Area Network (LAN) that includes desktop computers, laptop computers, smart phones, and tablets connected to a physical and wireless network, where users correspond to teachers and students. In this example, physical devices may be in buildings or a campus that is controlled by the school. As another example, an entity such as a business can operate a Wide Area Network (WAN) that includes physical devices in multiple geographic locations where the offices of the business are located. In this example, the different offices can be inter-networked using a combination of public networks such as the Internet and private networks. As another example, an entity can operate a data center: a centralized location where computing resources are kept and maintained, and whose resources are accessible over a network. In this example, users associated with the entity that operates the data center can access the computing resources in the data center over public and/or private networks that may not be operated and controlled by the same entity. Alternatively, or additionally, the operator of the data center may provide the computing resources to users associated with other entities, for example on a subscription basis. In both of these examples, users may expect resources to be available on demand and without direct active management by the user, a resource delivery model often referred to as cloud computing.

Entities that operate computing environments need information about their computing environments. For example, an entity may need to know the operating status of the various computing resources in the entity's computing environment, so that the entity can administer the environment, including performing configuration and maintenance, performing repairs or replacements, provisioning additional resources, removing unused resources, or addressing issues that may arise during operation of the computing environment, among other examples. As another example, an entity can use information about a computing environment to identify and remediate security issues that may endanger the data, users, and/or equipment in the computing environment. As another example, an entity may be operating a computing environment for some purpose (e.g., to run an online store, to operate a bank, to manage a municipal railway, etc.) and information about the computing environment can aid the entity in understanding whether the computing environment is serving its purpose well.

To this end, a set of users 106 such as a security team (or other types of users seeking to monitor an attack surface), via use of one or more client computing devices 108, can interact with the attack surface management system 102 to monitor one or multiple IT environments 150A-150N (whether located within a provider network 108 as IT environment 150N or in separate locations as IT environments 150A-150M) including computing resources 152A-152N. Broadly, the attack surface management system 102 may obtain metadata corresponding to various potential attack targets (e.g., collected and/or stored in a repository 110 such as a database, object storage service location or bucket, filesystem location, data structure, or the like), analyze the data (such as by tagging the data via use of tag specifications 116), and update the metadata and/or publish results within the repository 110 and/or via one or more interfaces provided by the configuration and reporting system 118.

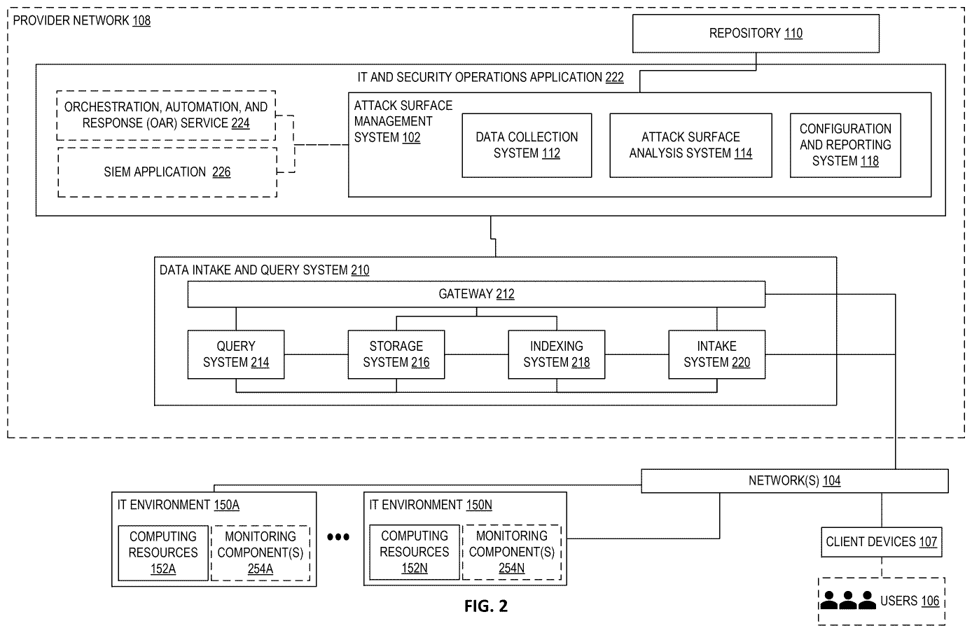

The attack surface management system 102 can be implemented in a variety of ways, potentially as part of a larger system or in conjunction with other systems. FIG. 2 illustrates an attack surface management system 102 implementing automated attack surface target tagging using user-configured tag specifications as part of an IT and security operations application according to some examples. The illustrated attack surface management system 102 is implemented as part of an IT and security operations application 222 that itself utilizes a data intake and query system 210 to monitor one or more IT environments 150A-150N, though of course many other architectures and implementation possibilities exist.

Generally, a data intake and query system 210 can ingest and store data obtained from the components in a computing environment, and can enable an entity to search, analyze, and visualize the data. Through these and other capabilities, the data intake and query system 210 can enable an entity to use the data for administration of the computing environment, to detect security issues, to understand how the computing environment is performing or being used, and/or to perform other analytics.

In some examples, the IT and security operations application 222, IT environments 150A-150N, and client devices 107 can communicate with each other via one or more networks 104, such as a local area network (LAN), wide area network (WAN), private or personal network, cellular networks, etc., using any of wired, wireless, terrestrial microwave, satellite links, etc., and may include the Internet, though ones of these components may be located within a common network. Thus, it is to be understood that a client computing device 107 can communicate with a host device (e.g., one of computing resources 152A-152N) via one or more networks 104. For example, if a host device of the computing resources 152A in a first IT environment 150A (e.g., a data center, a colocation space, a cloud network, an office building, a collection of multiple locations, etc.) is configured as a web server and a client computing device 107 is a laptop, the laptop can communicate with the web server to view a website.

Generally, a client device 107 can correspond to a distinct computing device that can configure, manage, or send queries (via requests) to the IT and security operations application 222. Examples of client devices 107 may include, without limitation, smart phones, tablet computers, handheld computers, wearable devices, laptop computers, desktop computers, servers, portable media players, gaming devices, or other devices that include computer hardware (e.g., processors, non-transitory computer-readable media, physical interfaces, etc.) and so forth. In certain cases, a client device 107 can include a hosted, virtualized, or containerized device, such as an isolated execution environment, that shares computing resources (e.g., processor, memory, etc.) of a particular machine with other isolated execution environments.

The client devices 107 can interact with the IT and security operations application 222 (or a computing resource 152) in a variety of ways. For example, client devices 107 can communicate with the IT and security operations application 222 (or a computing resource 152) over an Internet (Web) protocol, via a gateway, via a command line interface, via a software developer kit (SDK), a standalone application, etc. As another example, client devices 107 can use one or more executable applications or programs to interface with the IT and security operations application 222.

A computing resource 152 such as a host device can correspond to a distinct computing device or system that includes or has access to data that can be ingested, indexed, and/or searched by the data intake and query system 210. Accordingly, in some cases, a client device 107 may also be a computing resource (e.g., it can include data that is ingested by the data intake and query system 210 and it can submit queries to the system 210). Examples of computing resources 152 can include, but are not limited to, servers, sensors, routers, personal computers, mobile devices, Internet-of-Things (IOT) devices, or hosting devices, such as computing devices in a shared computing resource environment on which multiple isolated execution environment (e.g., virtual machines, containers, etc.) can be instantiated, or other computing devices in an IT environment (e.g., device that includes computer hardware, e.g., processors, non-transitory, computer-readable media, etc.). In certain cases, a computing resource 152 can include a hosted, virtualized, or containerized device, such as an isolated execution environment, that shares computing resources (e.g., processor, memory, etc.) of a particular machine (e.g., a hosting device or hosting machine) with other isolated execution environments.

As mentioned, computing resources 152 can include or have access to data sources for the data intake and query system 210. The data sources can include “machine data” (or machine-generated data) found in log files, data files, distributed file systems, streaming data, publication-subscribe (pub/sub) buffers, directories of files, data sent over a network, event logs, registries, streaming data services (examples of which can include, by way of non-limiting example, Amazon's Simple Queue Service (“SQS”) or Kinesis™ services, devices executing Apache Kafka™ software, or devices implementing the Message Queue Telemetry Transport (MQTT) protocol, Microsoft Azure EventHub, Google Cloud PubSub, devices implementing the Java Message Service (JMS) protocol, devices implementing the Advanced Message Queuing Protocol (AMQP)), cloud-based services (e.g., Amazon Web Services (AWS), Microsoft Azure, Google Cloud, etc.), operating-system-level virtualization environments (e.g., Docker), container orchestration systems (e.g., Kubernetes), virtual machines using full virtualization or paravirtualization, or other virtualization technique or isolated execution environments.

In some cases, one or more applications executing on a host device of computing resources 152 may generate various types of machine data during operation. For example, a web server application may generate one or more web server logs detailing interactions between the web server and any number of client devices 107 or other devices. As another example, a router may generate one or more router logs that record information related to network traffic managed or observed by the router. As yet another example, a database server application may generate one or more logs that record information related to requests or queries sent from other devices (e.g., web servers, application servers, client devices, etc.) for data managed by the database server. Similarly, a computing resource 152 may generate and/or store computing resource utilization metrics, such as, but not limited to, CPU utilization, memory utilization, number of processes being executed, etc. Any one or any combination of the files or data generated in such cases can be used as a data source for the data intake and query system 210.

In some examples, an IT environment 150A-150N may include a monitoring component 254A-254N that facilitates generating performance data related to a host device's operating state, including monitoring network traffic sent and received from the host device, and collecting other device and/or application-specific information. A monitoring component may be implemented as software as an integrated component of an application, a plug-in, an extension, or any other type of add-on component, or a stand-alone process.

Such monitored information may include, but is not limited to, network performance data (e.g., a URL requested, a connection type (e.g., HyperText Transfer Protocol (HTTP), HTTPS, etc.), a connection start time, a connection end time, an HTTP status code, request length, response length, request headers, response headers, connection status (e.g., completion, response time(s), failure, etc.)) or device performance information (e.g., current wireless signal strength of the device, a current connection type and network carrier, current memory performance information, processor utilization, memory utilization, a geographic location of the device, a device orientation, and any other information related to the operational state of the host device, etc.), device profile information (e.g., a type of client device, a manufacturer, and model of the device, versions of various software applications installed on the device, etc.) In some cases, the monitoring component can collect device performance information by monitoring one or more host device operations, or by making calls to an operating system and/or one or more other applications executing on a host device for performance information. The monitored information may be stored in one or more files and/or streamed to the data intake and query system 210.

In general, a monitoring component 254 may be configured to generate performance data in response to a monitor trigger in the code of a client application or other triggering application event, as described above, and to store the performance data in one or more data records. Each data record, for example, may include a collection of field-value pairs, each field-value pair storing a particular item of performance data in association with a field for the item. For example, a data record generated by a monitoring component may include a “networkLatency” field (not shown in the Figure) in which a value is stored. This field indicates a network latency measurement associated with one or more network requests. The data record may include a “state” field to store a value indicating a state of a network connection, and so forth for any number of aspects of collected performance data.

In some examples, such as in a shared computing resource IT environment 150 (or hosted environment), a computing resource 152 (e.g., a host device) may include logs or machine data generated by an application executing within an isolated execution environment (e.g., web server log file if the isolated execution environment is configured as a web server or database server log files if the isolated execution environment is configured as database server, etc.), machine data associated with the computing resources assigned to the isolated execution environment (e.g., CPU utilization of the portion of the CPU allocated to the isolated execution environment, memory utilization of the portion of the memory allocated to the isolated execution environment, etc.), logs or machine data generated by an application that enables the isolated execution environment to share resources with other isolated execution environments (e.g., logs generated by a Docker manager or Kubernetes manager executing on the host device), and/or machine data generated by monitoring the computing resources of the host device (e.g., CPU utilization, memory utilization, etc.) that are shared between the isolated execution environments. Given the separation (and isolation) between isolated execution environments executing on a common computing device, in certain examples, each isolated execution environment may be treated as a separate host device even if they are, in fact, executing on the same computing device or hosting device.

Accordingly, as used herein, obtaining data from a data source may refer to communicating with a host device (computing resource) to obtain data from the host device (e.g., from one or more data source files, data streams, directories on the host device, etc.). For example, obtaining data from a data source may refer to requesting data from a host device and/or receiving data from a host device. In some such cases, the host device can retrieve and return the requested data from a particular data source and/or the data intake and query system 210 can retrieve the data from a particular data source of the host device (e.g., from a particular file stored on a host device).

The data intake and query system 210, in some examples, can ingest, index, and/or store data from heterogeneous data sources and/or computing resources 152. For example, the data intake and query system 210 can be adapted to ingest, index, and/or store various types of machine data, regardless of the form of the machine data or whether the machine data matches or is similar to other machine data ingested, indexed, and/or stored by the data intake and query system 210. In some cases, the data intake and query system 210 can generate “events” from the received data, group the events, and store the events in storage locations (e.g., a “bucket” data structure such as a folder, directory, label, or the like). The data intake and query system 210 can also search heterogeneous data that it has stored, or search data stored by other systems (e.g., data of a SIEM application 226, or other system). For example, in response to received queries, the data intake and query system 210 can assign one or more components to search events stored in the storage system or search data stored elsewhere.

As will be described herein in greater detail below, the data intake and query system 210 can use one or more components to ingest, index, store, and/or search data. In some examples, the data intake and query system 210 is implemented as a distributed system that uses multiple components to perform its various functions. For example, the data intake and query system 210 can include any one or any combination of an intake system 220 (including one or more components) to ingest data, an indexing system 218 (including one or more components) to index the data, a storage system 216 (including one or more components) to store the data, and/or a query system 214 (including one or more components) to search the data, etc.

In the illustrated example, the data intake and query system 210 is shown having subsystems 214, 216, 218, 220, as well as a gateway 212 (e.g., providing an interface allowing interaction with external devices or to facilitate communications between components of the system 210). However, it will be understood that the data intake and query system 210 may include any one or any combination of these components. Further, in certain examples, one or more of the intake system 220, indexing system 218, query system 214, and/or storage system 216 may be used alone or apart from the data intake and query system 210. For example, the intake system 220 may be used alone to glean information from streaming data that is not indexed or stored by the data intake and query system 210, or the query system 214 may be used to search data that is unaffiliated with the data intake and query system 210.

In certain examples, the components of the different systems may be distinct from each other or there may be some overlap. For example, one component of the data intake and query system 210 may include some indexing functionality and some searching functionality and thus be used as part of the indexing system 218 and query system 214, while another computing device of the data intake and query system 210 may only have ingesting or search functionality and only be used as part of those respective systems. Similarly, the components of the storage system 216 may include data stores of individual components of the indexing system and/or may be a separate shared data storage system, such as a cloud-based object storage service such as the Amazon Simple Storage Service (S3)™ service, that is accessible to distinct components of the intake system 220, indexing system 218, and/or query system 214.

In some cases, the components of the data intake and query system 210 are implemented as distinct computing devices having their own computer hardware (e.g., processors, non-transitory, computer-readable media, etc.) and/or as distinct hosted devices (e.g., isolated execution environments) that share computing resources or hardware in a shared computing resource environment.

For simplicity, references made herein to the intake system 220, indexing system 218, storage system 216, and query system 214 can refer to those components used for ingesting, indexing, storing, and searching, respectively. However, it will be understood that although reference is made to various separate systems, the same underlying component may be performing the functions for the various different systems. For example, reference to the indexing system 218 indexing data and storing the data in the storage system 216 or the query system 214 searching the data may refer to the same component (e.g., same computing device or hosted device) indexing the data, storing the data, and then searching the data that it stored.

As will be described in greater detail herein, the intake system 220 can receive data from IT environments 150A-150N (e.g., computing resources 152 such as host devices or other data sources), perform one or more preliminary processing operations on the data, and communicate the data to the indexing system 218, query system 214, storage system 216, or to other systems (which may include, for example, data processing systems, telemetry systems, real-time analytics systems, data stores, databases, etc., any of which may be operated by an operator of the data intake and query system 210 or a third party). Given the amount of data that can be ingested by the intake system 220, in some examples, the intake system can include multiple distributed computing devices or components working concurrently to ingest the data.

The intake system 220 can receive data from the IT environments 150 in a variety of formats or structures. In some examples, the received data corresponds to raw machine data, structured or unstructured data, correlation data, data files, directories of files, data sent over a network, event logs, registries, messages published to streaming data sources, performance metrics, sensor data, image and video data, etc.

The preliminary processing operations performed by the intake system 220 can include, but is not limited to, associating metadata with the data received from a host device, extracting a timestamp from the data, identifying individual events within the data, extracting a subset of machine data for transmittal to the indexing system 218, enriching the data, etc. As part of communicating the data to the indexing system 218, the intake system 220 can route the data to a particular component of the intake system 220 or dynamically route the data based on load-balancing, etc. In certain cases, one or more components of the intake system 220 can be installed within an IT environment 150, such as on a host device itself.

As will be described in greater detail herein, the indexing system 218 can include one or more components (e.g., indexing nodes implemented by one or more computing devices, where one or more nodes can be implemented by any particular computing device) to process the data and store it, for example, in the storage system 216. As part of processing the data, the indexing system 218 can identify distinct events within the data, timestamps associated with the data, organize the data into buckets (e.g., a collection of data elements) or time series buckets (e.g., a collection of data elements having associated timestamps within some time range), convert editable buckets to non-editable buckets, store copies of the buckets in the storage system 216, merge buckets, generate indexes of the data, etc. In addition, the indexing system 218 can update various catalogs or databases with information related to the buckets (pre-merged or merged) or data that is stored in the storage system 216 and can communicate with the intake system 220 about the status of the data storage.

The query system 214, in some examples, includes one or more components to receive, process, and execute queries. In some cases, the query system 214 can use a same component to process and execute the query or can use one or more components to receive and process the query (e.g., a search head) and then one or more other components to execute at least a portion of the query (e.g., search nodes). In some cases, a search node and an indexing node may be implemented by the same computing device or hosted device performing different functions. In certain cases, a search node can be a separate computing device or hosted device from that implementing an indexing node.

Queries received by the query system 214 (e.g., from ones of the client devices 107 or another query source) can be relatively complex and identify a set of data to be processed and a manner of processing the set of data. In some cases, the query can be implemented using a pipelined command language or other query language (e.g. a SQL type query language, Big Data type query language, or the like). As described herein, in some cases, the query system 214 can execute parts of the query in a distributed fashion (e.g., one or more mapping phases or parts associated with identifying and gathering the set of data identified in the query) and execute other parts of the query on a single component (e.g., one or more reduction phases). However, it is to be understood that in some cases multiple components can be used in the map and/or reduce functions of the query execution.

In some cases, as part of executing the query, the query system 214 can use one or more catalogs or databases to identify the set of data to be processed or its location in the storage system 216 and/or can retrieve data from the storage system 216. In addition, in some examples, the query system 214 can store some or all of the query results in the storage system 216.

In some cases, the storage system 216 may include one or more data stores associated with or coupled to the components of the indexing system 218 that are accessible via a system bus or local area network. In certain examples, the storage system 216 may be a shared storage system 216, such as that provided by a cloud-based object storage service like Amazon S3™ or Google Cloud Storage™, which are accessible via a wide area network.

The storage system 216, in some examples, includes one or more data stores storing data that has been processed by the indexing system 218. The storage system 216 includes data stores of the components of the indexing system 218 and/or query system 214. In some examples, the storage system 216 can be implemented as a shared storage system configured to provide high availability, highly resilient, low loss data storage. In some examples, to provide high availability, highly resilient, low loss data storage, the shared storage system 216 can store multiple copies of the data in different geographic locations, potentially across different types of data stores (e.g., solid state, hard drive, tape, etc.). Further, as data is received at the shared storage system 216 it can be automatically replicated multiple times according to a replication factor to different data stores across the same and/or different geographic locations. In some examples, the shared storage system 216 can correspond to “cloud” storage, such as Amazon S3™ or Elastic Block Storage (EBS)™, Google Cloud Storage™, Microsoft Azure Storage™, etc.

In some examples, the indexing system 218 can read to and write from the storage system 216. For example, the indexing system 218 can copy buckets of data from its local or shared data stores to the storage system 216. In certain examples, the query system 214 can read from, but cannot write to, the storage system 216. For example, the query system 214 can read the buckets of data stored in shared storage system 216 by the indexing system 218 but may not be able to copy buckets or other data to the shared storage system 216. In some examples, the intake system 220 does not have direct access to the storage system 216. However, in some examples, one or more components of the intake system 220 can write data to the shared storage system 216 that can be read by the indexing system 218.

As described herein, in some examples, data in the data intake and query system 210 (e.g., in the data stores of the components of the indexing system 218, storage system 216, or search nodes of the query system 214) can be stored in one or more time series buckets. Each bucket can include raw machine data that is associated with a timestamp (e.g., within a range of timestamps, or having a particular timestamp) and additional information about the data or bucket, such as, but not limited to, one or more filters, indexes (e.g., a time-series index or “TSIDX”, inverted indexes, keyword indexes, etc.), bucket summaries, etc. In some examples, the bucket data and information about the bucket data is stored in one or more files. For example, the raw machine data, filters, indexes, bucket summaries, etc. can be stored in respective files in or associated with a bucket. In certain cases, the group of files can be associated together to form the bucket.

The data intake and query system 210 can include additional components that interact with any one or any combination of the intake system 220, indexing system 218, query system 214, and/or storage system 216. Such components may include, but are not limited to an authentication system, orchestration system, one or more catalogs or databases, gateway 212, etc.

An authentication system can include one or more components to authenticate users to access, use, and/or configure the data intake and query system 210. Similarly, the authentication system can be used to restrict what a particular user can do on the data intake and query system 210 and/or what components or data a user can access, etc., which can be based on per-user policies, user group policies (in which a user belongs to), or the like.

An orchestration system can include one or more components to manage and/or monitor the various components of the data intake and query system 210. In some examples, the orchestration system can monitor the components of the data intake and query system 210 to detect when one or more components has failed or is unavailable and enable the data intake and query system 210 to recover from the failure (e.g., by adding additional components, fixing the failed component, or having other components complete the tasks assigned to the failed component). In certain cases, the orchestration system can determine when to add components to or remove components from a particular sub-system 212, 214, 216, 218, 220 (e.g., based on usage, user/tenant requests, etc.). In examples where the data intake and query system 210 is implemented in a shared computing resource environment, the orchestration system can facilitate the creation and/or destruction of isolated execution environments or instances of the components of the data intake and query system 210, etc.

In certain examples, the data intake and query system 210 can include various components that enable it to provide stateless services or enable it to recover from an unavailable or unresponsive component without data loss in a time efficient manner. For example, the data intake and query system 210 can store contextual information about its various components in a distributed way such that if one of the components becomes unresponsive or unavailable, the data intake and query system 210 can replace the unavailable component with a different component and provide the replacement component with the contextual information. In this way, the data intake and query system 210 can quickly recover from an unresponsive or unavailable component while reducing or eliminating the loss of data that was being processed by the unavailable component.

The data intake and query system 210, in some examples, can store the contextual information in a catalog, as described herein. In certain examples, the contextual information can correspond to information that the data intake and query system 210 has determined or learned based on use. In some cases, the contextual information can be stored as annotations (manual annotations and/or system annotations), as described herein.

The data intake and query system 210, in some examples, can include an additional catalog that monitors the location and storage of data in the storage system 216 to facilitate efficient access of the data during search time. Such a catalog may form part of storage system 216.

In some examples, the data intake and query system 210 can include a gateway 212 or other mechanism to interact with external devices or to facilitate communications between components of the data intake and query system 210. In some examples, gateway 212 can be implemented to expose/provide/support an API, which in some examples is a representational state transfer API (REST API).

In some examples, a user of the IT and security operations application 222 may install and configure, on computing devices owned and operated by the user (or an organization associated with the user), one or more software applications that implement some or all of the components of the IT and security operations application 222. For example, with reference to FIG. 2, a user may install a software application on one or more server computing devices owned by the user or the user's organization (e.g., server computing devices of computing resources 152A-152N of IT environments 150A-150N) and configure these applications to operate as one or more components of the intake system 220, indexing system 218, query system 214, storage system 216, or other components of the IT and security operations application 222. This arrangement generally may be referred to as an “on-premises” (or “on-prem”) solution in that some or all of the IT and security operations application 222 is installed and operate on computing devices directly controlled by the user of the IT and security operations application 222. Some users may prefer an on-premises solution because it may provide a greater level of control over the configuration of certain aspects of the system (e.g., security, privacy, standards, controls, etc.). However, other users may instead prefer an arrangement in which the user is not directly responsible for providing and managing the computing devices upon which various components of IT and security operations application 222 operate.

Accordingly, in some examples, one or more (or all) of the components of the IT and security operations application 222 can be implemented in a separate computing resource environment. In some examples, this separate environment is a shared computing resource environment (e.g., withing a service provider network 108) or cloud-based service that refers to a service hosted by one more computing resources that are accessible to end users over a network (e.g., network(s) 104), for example, by using a web browser or other application on a client device 107 to interface with the remote computing resources. For example, a service provider may provide an IT and security operations application 222 by managing computing resources configured to implement various aspects of the system (e.g., intake system 220, indexing system 218, query system 214, storage system 216, SIEM application 226, other components, etc.) and by providing access to the IT and security operations application 222 to end users via a network. Typically, a user (e.g., an individual user, an organization, etc.) may pay a subscription or other fee to use such a service. Each subscribing user of the cloud-based service may be provided with one or more accounts that enable the user to configure a customized cloud-based system based on the user's preferences.

When implemented in a shared computing resource environment, the underlying hardware (non-limiting examples: processors, hard drives, solid-state memory, Random Access Memory (RAM), etc.) on which the components of the IT and security operations application 222 execute may be shared by multiple customers or tenants as part of the shared computing resource environment. In addition, when implemented in a shared computing resource environment as a cloud-based service, various components of the IT and security operations application 222 can be implemented using containerization or operating-system-level virtualization, or another virtualization technique. For example, one or more components of the intake system 220, indexing system 218, query system 214, SIEM application 226, orchestration, automation, and response (OAR) service 224, attack surface management system 102, etc., can be implemented as or using separate virtual machine instances and/or software containers. A software container instance can have certain computing resources (e.g., memory, processor, etc.) of an underlying hosting computing system (e.g., server, microprocessor, etc.) assigned to it, but may share the same operating system and may use the operating system's system call interface. Each container instance may provide an isolated execution environment on the host system, such as by providing a memory space of the hosting system that is logically isolated from memory space of other containers. Further, each container instance may run the same or different computer applications concurrently or separately and may interact with each other. Although reference is made herein to containerization and container instances, it will be understood that other virtualization techniques can be used. For example, the components can be implemented using virtual machines using full virtualization or paravirtualization, etc. Thus, where reference is made to “containerized” components, it should be understood that such components may additionally or alternatively be implemented in other isolated execution environments, such as a virtual machine environment.

Implementing the IT and security operations application 222 in a shared computing resource environment can provide a number of benefits. In some cases, implementing the IT and security operations application 222 in a shared computing resource environment can make it easier to install, maintain, and update the components of the IT and security operations application 222. For example, rather than accessing designated hardware at a particular location to install or provide a component of the IT and security operations application 222, a component can be remotely instantiated or updated as desired. Similarly, implementing the IT and security operations application 222 in a shared computing resource environment or as a cloud-based service can make it easier to meet dynamic demand. For example, if IT and security operations application 222 experiences significant load at indexing or search, additional compute resources can be deployed to process the additional data or queries. In an “on-premises” environment, this type of flexibility and scalability may not be possible or feasible.

In addition, by implementing the IT and security operations application 222 in a shared computing resource environment or as a cloud-based service can improve compute resource utilization. For example, in an on-premises environment if the designated compute resources are not being used by, they may sit idle and unused. In a shared computing resource environment, if the compute resources for a particular component are not being used, they can be re-allocated to other tasks within the IT and security operations application 222 and/or to other systems unrelated to the IT and security operations application 222.

As mentioned, in an on-premises environment, data from one instance of an IT and security operations application 222 can be logically and physically separated from the data of another instance of an IT and security operations application 222 by virtue of each instance having its own designated hardware. As such, data from different users of IT and security operations application 222 is logically and physically separated from each other. In a shared computing resource environment, components of IT and security operations application 222 can be configured to process the data from one customer or tenant or from multiple customers or tenants. Even in cases where a separate component of an IT and security operations application 222 is used for each user, the underlying hardware on which the components of the IT and security operations application 222 are instantiated may still process data from different tenants. Accordingly, in a shared computing resource environment, the data from different tenants may or may not be physically separated on distinct hardware devices. For example, data from one tenant may reside on the same hard drive as data from another tenant or be processed by the same processor. In such cases, IT and security operations application 222 can maintain logical separation between tenant data. For example, IT and security operations application 222 can include separate directories for different tenants and apply different permissions and access controls to access the different directories or to process the data, etc.

In some examples, tenant data from different tenants is mutually exclusive and/or independent from each other. For example, Tenant A and Tenant B do not share the same data, similar to the way in which data from a local hard drive of User A is mutually exclusive and independent of the data (and not considered part) of a local hard drive of User B. While Tenant A and Tenant B may have matching or identical data, each tenant would have a separate copy of the data. For example, with reference again to the local hard drive of User A and User B example, each hard drive could include the same file. However, each instance of the file would be considered part of the separate hard drive and would be independent of the other file. Thus, one copy of the file would be part of User A's hard drive and a separate copy of the file would be part of User B's hard drive. In a similar manner, to the extent Tenant A has a file that is identical to a file of Tenant B, each tenant would have a distinct and independent copy of the file stored in different locations on a data store or on different data stores.

Further, in certain cases, the IT and security operations application 222 can maintain the mutual exclusivity and/or independence between tenant data even as the tenant data is being processed, stored, and searched by the same underlying hardware. In certain cases, to maintain mutual exclusivity and/or independence between the data of different tenants, IT and security operations application 222 can use tenant identifiers to uniquely identify data associated with different tenants.

In a shared computing resource environment, some components of the IT and security operations application 222 can be instantiated and designated for individual tenants and other components can be shared by multiple tenants. In certain examples, a separate intake system 220, indexing system 218, and query system 214 can be instantiated for each tenant (e.g., by hosting different virtual machines, container instances, etc., for each tenant), whereas the storage system 216 or other components (e.g., data store, metadata catalog, and/or acceleration data store, described below) can be shared by multiple tenants. In some such examples where components are shared by multiple tenants, the components can maintain separate directories for the different tenants to ensure their mutual exclusivity and/or independence from each other. Similarly, in some such examples, the IT and security operations application 222 can use different hosting computing systems or different isolated execution environments to process the data from the different tenants as part of the intake system 220, indexing system 218, and/or query system 214.

In some examples, individual components of the intake system 220, indexing system 218, and/or query system 214 may be instantiated for each tenant or shared by multiple tenants. For example, some individual intake system components (e.g., forwarders, output ingestion buffer) may be instantiated and designated for individual tenants, while other intake system components (e.g., a data retrieval subsystem, intake ingestion buffer, and/or streaming data processor), may be shared by multiple tenants.

In certain examples, an indexing system 218 (or certain components thereof) can be instantiated and designated for a particular tenant or shared by multiple tenants. In some examples where a separate indexing system 218 is instantiated and designated for each tenant, different resources can be reserved for different tenants. For example, Tenant A can be consistently allocated a minimum of four indexing nodes and Tenant B can be consistently allocated a minimum of two indexing nodes. In some such examples, the four indexing nodes can be reserved for Tenant A and the two indexing nodes can be reserved for Tenant B, even if Tenant A and Tenant B are not using the reserved indexing nodes.

In examples where an indexing system 218 is shared by multiple tenants, components of the indexing system 218 can be dynamically assigned to different tenants. For example, if Tenant A has greater indexing demands, additional indexing nodes can be instantiated or assigned to Tenant A's data. However, as the demand decreases, the indexing nodes can be reassigned to a different tenant or terminated. Further, in some examples, a component of the indexing system 218 can concurrently process data from the different tenants.

In some examples, one instance of query system 214 may be shared by multiple tenants. In some such cases, the same search head can be used to process/execute queries for different tenants and/or the same search nodes can be used to execute queries for different tenants. Further, in some such cases, different tenants can be allocated different amounts of compute resources. For example, Tenant A may be assigned more search heads or search nodes based on demand or based on a service level arrangement than another tenant. However, once a search is completed the search head and/or nodes assigned to Tenant A may be assigned to Tenant B, deactivated, or their resource may be re-allocated to other components of the IT and security operations application 222, etc.

In some cases, by sharing more components with different tenants, the functioning of the IT and security operations application 222 can be improved. For example, by sharing components across tenants, system 210 can improve resource utilization thereby reducing the numbers or amounts of resources allocated as a whole. For example, if four indexing nodes, two search heads, and four search nodes are reserved for each tenant, then those compute resources are unavailable for use by other processes or tenants, even if they go unused. In contrast, by sharing the indexing nodes, search heads, and search nodes with different tenants and instantiating additional compute resources, the IT and security operations application 222 can use fewer resources overall while providing improved processing time for the tenants that are using the compute resources. In some cases, by keeping computing resources in more active use, these computing resources may even be able to quickly perform tasks for its users, e.g., by having resources, code, etc., in a “hot” state meaning it can be more responsive, as opposed to having resources in a “cold” state (e.g., in an idle or sleeping state) that may take longer to be ready to act. For example, if Tenant A is not using any search nodes and Tenant B has many searches running, the IT and security operations application 222 can use search nodes that would have been reserved for Tenant A to service Tenant B. In this way, IT and security operations application 222 can decrease the number of compute resources used/reserved, while improving the search time for Tenant B and improving compute resource utilization. Thus, fewer physical computing resources may be needed (leading to reduced energy utilization, fewer points of failure, lower costs for all) while overall system performance can be improved.

As shown in FIG. 2, the IT and security operations application 222 may include a security management application, such as a security information and event management (SIEM) application 226, comprising software components executed by one or more electronic computing devices. The computing devices, in some examples, are provided by a cloud provider network 108 (e.g., as part of a shared computing resource environment). In other examples, the SIEM application 226 operates on computing devices managed within an on-premises datacenter or other computing environment, or on computing devices located within a combination of cloud-based and on-premises computing environments.

Generally, a SIEM application 226 can provide analysis and management functionalities for security-related “events” (or findings, intermediate findings, or the like) generated based on computing activity. A SIEM application 226 may also provide analytical tools having a range of functions including trend analysis, event identification, and alerting. For example, a SIEM application 226 can utilize data (e.g., machine data, unstructured data, weblogs, etc.) collected by the data intake and query system 210 from one or more computing resources 152A-152N to identify security-related events (and/or groups of events) based on criteria and/or present summaries of events or groups of events via one or more graphical user interfaces (GUIs), such as those implementing a security console. Examples of computing resources 152 from which data can be collected can include one or more computing devices, e.g., a server computing device, a router, network devices, user device, or more specifically, from software systems implemented by those devices. These events can pertain to an activity occurring within the IT environments 150, such as a computer action, access control decision, endpoint activity, a communication (sent or received over a network), network activity (e.g., network requests, connection attempts, traffic via a network device (e.g., a firewall, a router, a switch, or a network), requests for proxy or HTTP data, or creation of new domains), or other activity. Thus, a SIEM application 226 can enable security teams to quickly detect and respond to internal and external attacks, simplify threat management, and safeguard computing resources. In some examples, the SIEM application 226 enables security teams (e.g., analyst teams) to use data to gain organization-wide visibility and security intelligence whether users'resources are deployed on-premises, in a public or private cloud, or in any combination of these. The SIEM application 226 can be used for continuous monitoring, incident response, running a security operations center or for providing users with a window into business risk, among other features.

Users 106 associated with IT operations or security teams (sometimes referred to herein as “analysts”) can use various client devices 108 to interact with the SIEM application 126 via one or more network(s) 104 to analyze information related to IT environments for which they are responsible (such as, for example, one or more IT environments 150A, . . . , 150N, which may be accessible over one or more other network(s) that may be the same or different from network(s) 104). In some implementations, any number of separate analyst teams can concurrently use the SIEM application 126 to monitor any number of respective IT environments, where each security team may be responsible for one or more tenant networks.

In some examples, users can interact with SIEM application 126 and data intake and query system 210 using client devices 108. The client devices 108 may communicate with the SIEM application 126 and with data intake and query system 210 in a variety of ways such as, for example, over an internet protocol via a web browser or other application, via a command line interface, via a software developer kit (SDK), and the like. In some examples, client devices 108 can use one or more executable applications or programs from the application environment to interface with the data intake and query system 210, such as the SIEM application 126. The SIEM application 126 can interface with the data intake and query system 210 to obtain relevant data, process the data, and display it in a manner relevant to the IT operations context. As shown, the SIEM application 126 further includes additional backend services, middleware logic, front-end user interfaces, data stores, and other computing resources, and provides other facilities for ingesting use case specific data and interacting with that data.

The SIEM application 126 can include a front-end service providing a number of interfaces, such as security posture interfaces, incident review interfaces, security operations interfaces, finding-based detection interfaces, among many other possible types of interfaces that can be provided to users to display information. In some examples, the SIEM application 126 further includes middleware business logic implemented on a middleware platform of the developer's choice. Furthermore, in some examples, a SIEM application 126 is instantiated and executed in a different isolated execution environment relative to the data intake and query system 210. As a non-limiting example, in examples where the data intake and query system 210 is implemented at least in part in a Kubernetes cluster, the SIEM application 126 may execute in a different Kubernetes cluster (or other isolated execution environment system) and interact with the data intake and query system 210 via the gateway 212.

In some examples, a user (also referred to herein as a “customer,” “tenant,” or “analyst”) of a SIEM application 126 can create one or more user accounts to be used by analysts or other users. A user of the SIEM application 126 can use the application to monitor one or more IT environments 150 for which the user is responsible (illustrated by example IT environments 150A, . . . , 150N). Each IT environment 150 can include any number of computing resources 152 (e.g., computing resources 152A, . . . , computing resources 152N) operating as part of a corporate network or other networked computing environment. Although the IT environments 150A-150N are shown as separate from the provider network 108 in FIG. 2, more generally, an IT environment 150 can include (partially or completely) computing resources hosted in an on-premises network, in the provider network 108, in another provider network, or any combinations thereof (e.g., as a hybrid cloud network).

Any of the computing resources 152 in an IT environment 150 can potentially serve as a source of incident-related data other data analyzed by a SIEM application 126. The computing resources 152A-152N can include various types of computing devices, software applications, and services including, but not limited to, a data intake and query system (which itself can ingest and process machine data generated by other computing resources), a SIEM system, a REST client that obtains or generates data based on the activity of other computing resources, software applications (including operating systems, databases, web servers, etc.), routers, intrusion detection systems and intrusion prevention systems (IDS/IDP), client devices (for example, servers, desktop computers, laptops, tablets, etc.), firewalls, switches, and the like. The computing resources 152 can execute upon any number separate computing devices and systems within an IT environment 150.

During operation, data intake and query systems, SIEM systems, REST clients, and other system components of IT environments obtain operational, performance, and security data from computing resources, analyze the data, and optionally identify potential IT-related incidents. A data intake and query system 210 in an IT environment, for example, might identify potential IT-related incidents based on the execution of one or more detections (also referred to as correlation searches) against data ingested and indexed by the system. Once obtained, data indicating such incidents is sent to the data intake and query system 210 or SEIM application 126 via an on-premises proxy or other type of forwarder. For example, data reflecting activity in the IT environments 150A-150N can be sent to the data intake and query system 210 via a REST API endpoint implemented by a gateway 212 or a similar gateway of the SIEM application 226. As mentioned elsewhere herein, a data intake and query system 210 or IT and security operations application 222 may ingest, index, and store data received from each IT environment in association with user accounts such that various users'data is segregated from other user data (for example, when stored in common storage of the data intake and query system 210).

The operation of an SIEM application 126 generally begins with the ingestion of data reflecting activity within one or more IT environments 152 (e.g., activity involving computing resources 152A of an IT environment 150A). In some examples, users configure a data intake and query system 210 or SIEM application 126 to obtain, or “ingest,” data from one or more defined data sources, where such data sources can be any type of computing device, application, or service that supplies information that users may want to store or analyze, and where such data sources may include one or more of the computing resources 152A-150N, or other data sources which generate data based on the activity of one or more computing resources. As mentioned, examples of data sources include, but are not limited to, a REST client, applications, routers, intrusion detection systems (IDS)/intrusion prevention systems (IDP) systems, client devices, firewalls, switches, monitoring components 254, or any other source of data reflecting activity in IT environments. Some of these data sources may themselves collect and process data from various other data generating components such as, for example, web servers, application servers, databases, firewalls, routers, operating systems, and software applications that execute on computer systems, mobile devices, sensors, Internet of Things (IoT) devices, etc. The data generated by the various data sources can be represented in any of a variety of data formats.

In some examples, data ingested by a data intake and query system 210 or SIEM application 126 from configured data sources can be represented in the SIEM application 126 by data structures referred to as “incidents, “intermediate findings” (or “events”), and/or “findings” (or “notables”). In some examples, a SIEM application 126 can be configured to create and recognize different types of incidents depending on the corresponding type of data ingested, such as “IT incidents” for IT operations-related incidents, “security incidents” for security-related incidents, and so forth. A finding (or “notable event”) can be stored, for example, in a findings index (or “notables index”) and can further include or be associated with (e.g., by storing identifiers thereof) any number of contributing intermediate findings (or events). As indicated above, a finding and/or intermediate finding can also be associated with one or more risk objects, where each risk object may correspond to an entity (e.g., a user, a virtual or physical computing device, an application, etc.). These entities (e.g., as represented via risk objects) may also have entity risk scores referred to as ERSs, which may be calculated based on metadata associated with findings and/or intermediate findings.

As introduced above, SIEM application 226 may identify security-related risks associated with an IT environment and, as one example, determine risk scores for these identified risks. In this context, a “risk score” can broadly refer to any type of quantitative value used to indicate an expected level of risk posed by an entity represented as a “risk object” (e.g., a data object representing a user, a physical or virtual computing device, or a software application) to an IT environment based on an analysis of data reflecting the risk object's activity. The SIEM application 226 can generate or obtain risk scores for risk objects in any number of ways including, but not limited to, executing correlation searches (or “detections”) against event data indicating activity within IT environments to identify potential incidents, using a risk score analysis framework to assign risk scores to events contributing to identified incidents and aggregating the risk scores for particular risk objects, receiving user input assigning a risk score to a risk object, and the like. For example, when a detection (e.g., a finding-based detection) identifies a set of events (e.g., risk events in a risk index, or intermediate findings) matching a specified criteria indicating activity of interest in an IT environment, the SIEM application 226 can generate an “alert” in the form of a finding 138 (e.g., or “notable event” stored in a notables index / set of findings) or other similar data object. The SIEM application 226 can further associate risk scores with intermediate findings contributing to the finding and, by extension, with risk objects associated therewith. These risk scores can provide one efficient measure of a given risk object's potential risk to an IT environment.

A host device in an IT environment may also generate machine data in the form of network traffic sent by the host to various other hosts. For example, a “detection” (e.g., search logic) that is designed to detect instances of a host sending personally identifiable information (PII) may result in the creation of several findings over a period of days, which indicate that the host might be sending PII. A detection may thus be configured to identify, within a collection of intermediate findings (e.g., events stored in risk index) reflecting network traffic sent by hosts in a computing environment, instances of data that appear to correspond to Social Security Numbers, credit card numbers, and the like. Responsive to the identification of this activity, a risk object corresponding to the host computing device can be assigned a risk score by a risk analysis framework of the SIEM application 226. The risk score can be assigned, for example, as part of executing the detection, based on an ad hoc adaptive response action, or using some other mechanism. Once assigned to the risk object, the risk score can be displayed in various interfaces provided by the SIEM application 226 to provide users with an indication of how risky the host sending the PII may be to a computing environment in which the host is operating.

The IT and security operations application 222 may additionally, or alternatively, include an Orchestration, Automation, and Response (OAR) service 224. An OAR service 224 can enhance an organization's cybersecurity posture by integrating and automating various security tools and processes. For example, an OAR service 224 can enable security teams to efficiently manage and respond to incidents by automating repetitive tasks, orchestrating workflows across different security systems, and/or provide comprehensive incident analysis and response capabilities, among other possible functionalities, resulting in faster threat detection, improved incident response times, and reduced manual workload, allowing security professionals to focus on more strategic activities. Accordingly, in some examples, an OAR service 224 performs a wide range of OAR capabilities such as action execution (via an action manager component), playbook execution (via a playbooks manager component), scheduling work to be performed (via a scheduler component), user approvals and so forth as workflows (via a workflows manager component), among other functionalities.

The operation of an OAR service 224 can include the ability to create and execute customizable “playbooks.” At a high level, a playbook comprises computer program code and possibly other data that can be executed by the IT and security operations application 100 to carry out an automated set of actions (for example, as managed by a playbooks manager as part of an OAR service 224). In some examples, a playbook is comprised of one or more functions, or codeblocks or function blocks, where each function contains program code that performs defined functionality when the function is encountered during execution of the playbook of which it is a part. As an example, a first function block of a playbook might implement an action that upon execution affects a first one or more computing resources 152A (e.g., by configuring a network setting, restarting a server, etc.); another function block might filter data generated by the first function block in some manner; yet another function block might obtain information from an external service, and so forth. A playbook can be further associated with a control flow that defines an order in which the IT and security operations application executes the function blocks of the playbook, where a control flow may vary at each execution of a playbook depending on particular input conditions (e.g., where the input conditions may derive from attributes associated with an incident triggering execution of the playbook or based on other accessible values).

Accordingly, an OAR service 224 can provide one or more playbook management interfaces that enable users to locate and organize playbooks associated with a user's account. A playbook management interface can display a list of playbooks that are associated with a user's account and further provide information about each playbook such as, for example, a name of the playbook, a description of the playbook's operation, a number of times the playbook has been executed, a last time the playbook was executed, a last time the playbook was updated, tags or labels associated with the playbook, a repository at which the playbook and the associated program code is stored, a status of the playbook, and the like.

Users can create a new digital playbook starting from a playbook management interface or using another interface provided by the OAR service 224. Using a playbook management interface, for example, a user can select a “create new playbook” interface element and the OAR service 224 causes display of a visual playbook editor interface including a graphical canvas on which users can add “nodes” (or “blocks”) representing operations to be performed during execution of the playbook, where the operations are implemented by associated source code (e.g., Python code, JavaScript code, etc.) that can be automatically generated by the visual playbook editor, and add connections or edges among the nodes defining an order in which the represented operations are to be performed upon execution.

In some examples, the creation of a graph representing a playbook includes the creation of connections between function blocks, where the connections are represented by edges that visually connect the nodes of the graph representing the collection of function blocks. These connections among the playbook function blocks indicate a program flow for the playbook, defining an order in which the operations specified by the playbook blocks are to occur. For example, if a user creates a connection that links the output of a block A to the input of a block B, then block A executes to completion before execution of block B begins during execution of the playbook. In this manner, output variables generated by the execution of block A can be used by block B (and any other subsequently executed blocks) during playbook execution. Thus, a playbook can be implemented as a directed graph of blocks that are executed according to some control flow ordering, which could be sequential (e.g., an ordered execution of blocks occurring one at a time), involve or utilize unconditional splits (e.g., after execution of a block, then two or more other blocks are executed), conditional splits (where one or more blocks are selected for execution based on some defined condition(s)), loops (where the same block may execute multiple times or execution may return to an earlier block in the playbook), or the like.

Once a user has codified a playbook using a visual playbook editor or other interface, the playbook can be saved (for example, in a multi-tenant database and in association with one or more user accounts) and run by the OAR service 224 in an on-demand manner. As illustrated in the example playbooks above, a playbook can include a “start” block that is associated with source code that begins execution of the playbook. In some examples, the OAR service 224 executes the function represented by the start block for a playbook with container context comprising data about the incident against which the playbook is executed, where the container context may be derived from input data from one or more configured data sources. A playbook can be executed manually in response to a user providing input requesting execution of the playbook, according to a schedule, automatically in response to the IT and security operations application 222 obtaining input events matching certain configured criteria. In examples where the source code associated with a playbook is based on an interpreted programming language (for example, such as the Python programming language), the OAR service 224 can execute the source code represented by the playbook using an interpreter and without compiling the source code into compiled code. In other examples, the source code associated with a playbook can first be compiled into byte code or machine code the execution of which can be invoked by the OAR service 224.

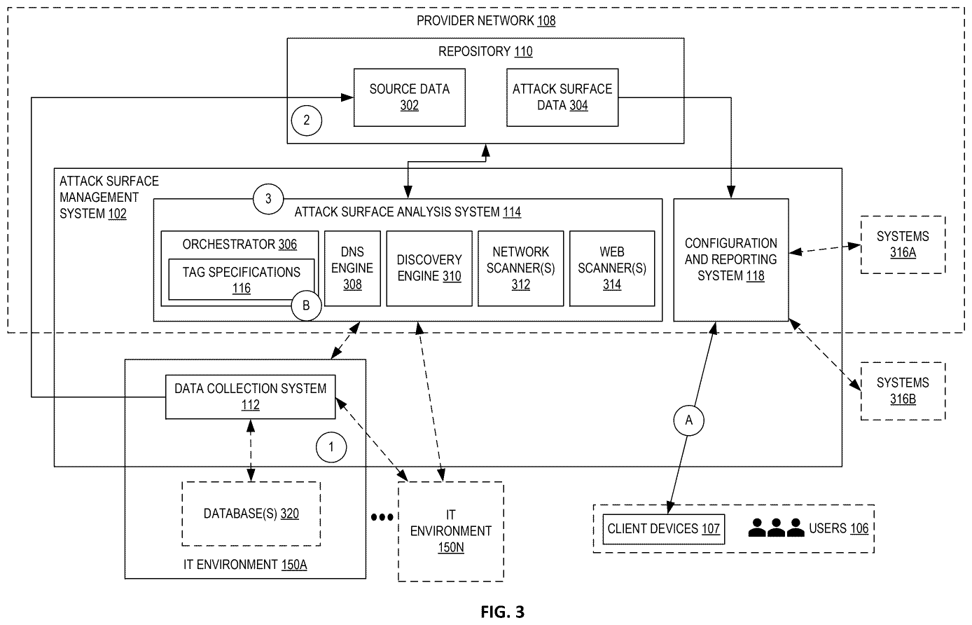

For further detail, FIG. 3 illustrates example computing components and operations of an attack surface management system for automated attack surface target tagging using user-configured tag specifications according to some examples.

As shown with regard to circle (A), a user 106 may utilize a client device 107 to configure the attack surface analysis system 114 for operation. For example, the configuration and reporting system 118 may expose an interface such as an API and/or provide data for a GUI to be presented to a user 106 such that a client device 107 can transmit data (e.g., via a request) to the configuration and reporting system 118 to configure or provide one or more tag specifications 116, which are provided to (or otherwise made accessible to) an orchestrator 306 at circle (B). In one example, the configuration and reporting system 118 is configured to allow for an upload of a file carrying one or more tag specifications 116, while in other example the configuration and reporting system 118 provides data for a GUI (e.g., a webpage or similar) enabling a user 106 to provide a tag specification 116 (e.g., by typing or pasting in alphanumeric text, by uploading a data structure) or configure a tag specification 116 (e.g., by selecting or utilizing one or more user input elements such as buttons, text inputs, and the like, as part of a form submission).

A tag specification 116, in some examples, is defined in an attack surface data serialization language, for example, in a format similar to YAML or JSON (JavaScript Object Notation), which can be a human-friendly, commonly-supported data serialization language that many technologists are already comfortable with, enabling users to quickly and easily understand the proper format, needed data, and the like. Tag specifications 116 can be “applied” to metadata regarding resources that are discovered or monitored by the attack surface analysis system 114 to identify those target resources that should be associated with a tag. These targets can thus be “tagged” with tags, determined based on the application of these tag specifications, through associating a record for the target with the associated tag(s) in a data structure (e.g., a database record), enabling targets to be identified based on these tags. For example, a cloud storage location could be associated with a number of tags, such as Network: CloudProvider1, Target Type:CloudProvider_Storage, IP:v4, Technology:Web, Protocol:HTTP, Protocol:HTTPS, Vendor:CloudProvider, Web:XML, etc. With such tags, users can quickly and easily find targets of interest (e.g., “find all targets using HTTPS” or “find all targets within NetworkX” or “find all instances of “database_product_1”). Moreover, automations can be developed to query or test particular targets based on identifying targets having a particular tag, such as via an OAR playbook.

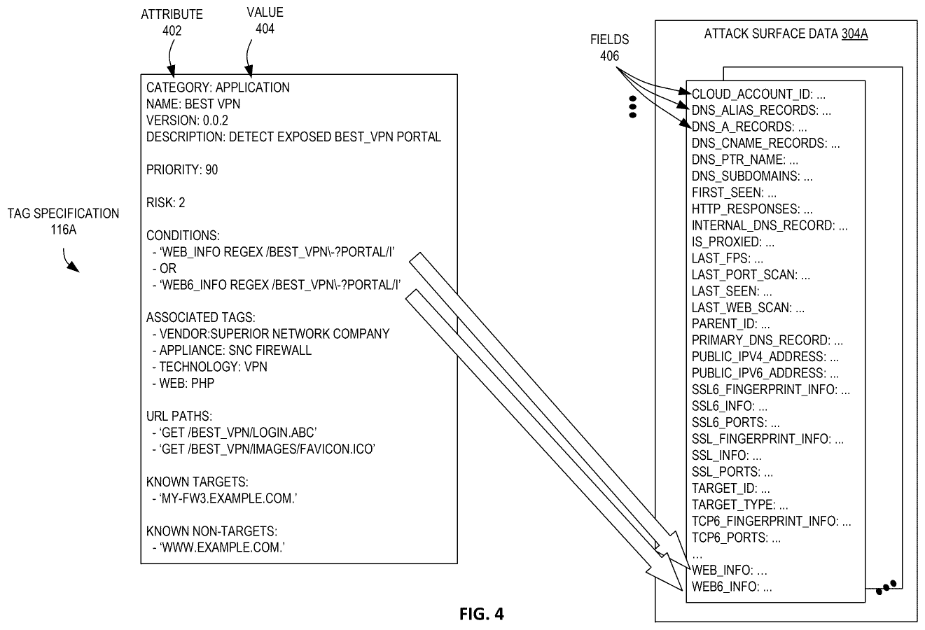

As one example, FIG. 4 illustrates an example tag specification 116A and attack surface data 304A that can be used for automated attack surface target tagging by an attack surface management system according to some examples. In this example, a tag specification 116A is provided in an attack surface data serialization language. This tag specification 116A includes multiple attributes 402, each with one or more associated values 404, and where an attribute may potentially be configured with a default value. In various examples, zero, one, or more of these attributes 402 (with one or more associated values 404) can be designated as required to allow for the tag specification 116A to be deemed valid (and thus added for use). As one simple example, in some use cases the first four attributes 402 may be deemed as required—a category, name, version, and description. In another example, only a name may be required, while in another example, a name and conditions are required. The selection of which—if any—attributes are required can flexibly be made by the implementor based on the implementation of the system, e.g., based on whether uniqueness among tag specifications must be insured, whether a default value can be set or allowed for an attribute, or the like.

In this example, a category attribute is provided allowing a user to define which category the tag specification 116A belongs to. This category can be used for managing and organizing the particular tag specifications used within a system, as potentially tens, hundreds, thousands or more can be in use at a time—users need the ability to identify which tag specifications have or have not already been defined, and this category can aid in that exploration. A category may thus be selected from a set of defined categories, and in some examples a new category can be created “on the fly” via a tag specification or at the time of incorporation of a tag specification into the system. Example categories include, but are not limited to, Appliance, Application, HyperText Transfer Protocol (HTTP), Internet Protocol (IP), Network, Operating System (OS), Other Protocol, Transmission Control Protocol (TCP), Transport Layer Security (TLS), Technology, User Datagram Protocol (UDP), Vendor, Web, or the like. In this illustrated example tag specification 116A, the category is set as ‘Application.’

The tag specification 116A illustrated in FIG. 4 also includes a “name” attribute used to give a typically-descriptive name for the tag specification, which may be required to be unique within the system (perhaps in combination with a next attribute of “version,” indicative of which version of the specification this pertains to), though such uniqueness may not be necessary in all examples. The tag specification 116A also includes a description attribute allowing the user to provide a textual description of what the tag specification 116A pertains to. In this example, the name is “BEST VPN,” the version of tag specification is 0.0.2, and the description indicates that the tag specification is for detecting an “exposed BEST_VPN portal.”

In some examples, either the name alone (e.g., “BEST VPN”), a combination of the category and name together (e.g., “CATEGORY:BEST VPN”), etc., can be used as the tag that is applied to a matching target. In some examples, this string value can be associated with a matching target in a data structure, such as by storing the tag with a target data structure, storing an identifier associated with the tag in the data structure (e.g., a unique identifier value such as an integer, which itself is associated with the tag). However, other ways to define a tag can be used, such as utilizing an explicit “tag” attribute 402 that a user can provide.

The tag specification 116A also includes a priority attribute. The priority attribute can be used to allow the user to provide a relative priority that indicates an ordering in which the tag specification 116A is to be processed (compared to other tag specifications). In some examples, this priority attribute can be set with a value, e.g., a numeric value in some range (such as 0-100), an enumerated category such as high/medium/low, or the like. Based on this priority attribute value, and the values from other tag specifications, the attack surface analysis system 114 can thus determine an order in which to evaluate (or “apply”) the tag specifications. This can allow the user to control the processing order, as it may be the case that the evaluation of a “later” tag specification may rely on (or require) the existence of another tag specification being processed earlier, which would cause a particular tag to be defined (that can be later referenced) or certain actions having been performed or data collected via tag specification processing (which may be referenced in the later tag specification's condition attribute, as described later herein). In this example, a high priority value is set (e.g., “90”), perhaps from an allowable range of 1-100, meaning that it will be processed after any other tag specifications having lower priority values.

A risk attribute is also included in the example tag specification 116A allowing a user to provide a risk severity score, which can be a numeric value, a categorical value (e.g., high/medium/low, yes/no), or the like. If such a risk attribute score is provided, the user can indicate that when the tag specification is applied and thus causes a tag to be applied to a target (or object) on the monitored attack surface, this target can be associated with an amount of risk, allowing for the target to be presented differently to analysts (e.g., in a “critical risk” display when the risk value is set sufficiently high enough, sent via a notification such as an email or in-application notification) and/or for automated actions to be performed based on this value (e.g., a target being terminated or deleted, further secured, network isolated, enhanced security being enabled, or the like). In this example, a (low) risk attribute value of “2” is provided, where the range may be between 0 -100 and a value of zero represents the lowest risk and one hundred represents the highest.

The example tag specification 116A also includes a set of one or more conditions that can be used, by the attack surface analysis system 114, to automatically determine which (if any) targets the tag specification is to apply to. The set of conditions can be configured, for example, using various operators and/or commands enabling the user to specify which source data is to be examined and how it is to be evaluated. For example, one or multiple conditions can be specified using a regular expressions type syntax identifying particular fields 406 of attack surface data 304A to be examined and how the values of these fields 406 are to be evaluated—e.g., using an “equals” or “not equals” comparison operator, using a greater than or less than operator, determining whether the value includes some number or substring, determining whether a provided regular expression matches the value, determining whether the value is or is not empty, etc. In some examples, multiple conditions can be combined in ways known to those of skill in the art, such as through use of “OR” or “AND” or “XOR” operators. In some examples, the conditions can also involve nested conditions and complex logical expressions. Various attack surface data 304A can be obtained by the attack surface management system 102 as will be described further herein. In the illustrated example, a variety of particular fields 406 are available, including a cloud account identifier, DNS alias record data, DNS A record data, DNS CNAME record data, DNS pointer name data, DNS subdomains, a first seen date and/or time, a set of HTTP responses obtained from the target, an internal DNS record, an indication of whether or not the target is proxied, a last FPS of the target, a last port scan date/time of the target, a last seen date/time of the target, a date/time of a last web scan of the target, a parent identifier, a primary DNS record of the target, etc.

In the illustrated example, two conditions are provided - the first analyzes the “WEB_INFO” field 406 and evaluates it using a regular expression. In this example, the regular expression “/best_vpn\-? portal/I” is designed to match strings that contain the phrase “best_vpnportal” or “best_vpn-portal” in a case-insensitive manner. Here, the forward slashes are delimiters that indicate the start and end of the regular expression, the string “best_vpn” matches the exact string “best_vpn”, the “\-?” portion matches a literal hyphen (while the ? makes it optional, meaning it will match whether the hyphen is present or not), the string “portal” matches the exact string “portal”, while the “I” flag at the end makes the matching case-insensitive, so it will match “best_vpnportal”, “Best_VpnPortal”, “BEST_VPNPORTAL”, etc.

This condition is combined with a second condition using an “OR” operator, meaning that the successful evaluation of either condition will cause the tag specification to be “matched” to a particular target object (e.g., a host computing device, a virtual machine, a software instance, a port, a network device, etc.). The second condition operates using a same regular expression as the first, though this time examining a different field 406—the “WEB6_INFO” field. Accordingly, the user that configured this tag specification 116A may know that this pattern may exist in either of these two fields 406 for targets of interest, and simply create these conditions to allow for such matching targets to be identified. Of course, this particular syntax and use case are exemplary, as many other types of condition definition syntax exist that could be utilized for similar or different usage scenarios.

In some examples, the inclusion of one or more conditions within a tag specification 116 is required, though in other examples it is not. As one example, a attack surface management system 102 can be implemented to support a tag specification 116 without any condition, in which case the tag specification 116 may match all targets or match no targets. This can allow for actions to be performed on every target (e.g., through attributes such as “URL paths” referenced in the following), and/or for the tag to be “loaded” such that it can be referenced by later-evaluated tag specifications, such as part of an associated tags attribute 402.

An associated tags attribute 402 is included in the illustrated example, and can be used to associate additional tags (along with the specific tag that the tag specification is for) with targets matched by the tag specification itself. Thus, in some examples, a user may provide zero, one, or more additional tags for association by providing them as values here. In the illustrated example, when the “condition” is satisfied (here, by one of the two stated conditions evaluating to true) for a target, the primary tag (“Application:Best VPN”) is associated with the target along with additional tags—here, “Vendor:Superior Network Company” and “Applicance:SNC Firewall” and “Technology:VPN” and “Web:PHP”. In this manner, a user can directly tag an asset with a variety of aspects of interest that may be inherent to those targets matching the tag specification, providing enhanced visibility into the target via different channels (via these different tags). This approach can beneficially allow for the incorporation of domain knowledge obtained by the user/analyst into the system. In some examples, these additional tags may have an associated tag specification that might not include any condition, as reflected earlier herein, and thus are “loaded” into the system for potential later use, such as through these associated tags. Accordingly, upon a tag specification “matching” a particular target, the target may be associated with zero tags, one tag, or even multiple tags.

A set of URL paths attribute 402 is also provided in the example of FIG. 4. In some example, a user can provide a set of commands and/or “path” values for use in constructing a URL associated with a detected target. Upon the tag specification 116 being evaluated and matching a target, the attack surface analysis system 114 may perform actions involving the target through these values. For example, the attack surface analysis system 114 may send requests to the target by combining the target's location (e.g., an IP address or hostname) with the provided path values, here using the indicated HTTP method. As a first example, the attack surface analysis system 114 may issue a first “GET” HTTP request toward a destination of 192.168.5.5 (an assumed internal IPv4 address of a target) by constructing and utilizing a destination URL of “http://192.158.5.5/best_vpn/login.abc”; likewise, a similar GET request for “http://192.158.5.5/best_vpn/images/favicon.ico” can also be sent. In this manner, the system can automatically perform additional actions based on the tag specification matching a target—here, requesting particular data from the target. This requested data can assist, for example, in the processing of subsequent tag specifications, further research on the part of the analyst(s), etc. More generally, in other examples this URL paths attribute 402 may be more broadly generalized into an “actions” attribute 402, where a user can provide code or commands for performing actions, which may or may not include sending HTTP requests, and may involve the use of shell commands, scripts, function calls, or the like.

The example tag specification 116A also includes a “known targets” attribute 402 and a “known non-targets” attribute 402, where a user can provide identifiers of targets that are known to match the tag specification, and identifiers of targets that are known to not match the tag specification, respectively. In this example, domain names are provided (e.g., my-fw3.example.com), though in various examples other identifiers can provided, such as hostnames, IP addresses, or the like. These attribute values can be used to validate the logic encapsulated by the conditions, where the attack surface analysis system 114 can test the validity of the tag specification 116A by ensuring that any “known targets” are in fact matched, and that none of the “known non-targets” are matched. If a target is wrongfully identified (or not identified), in various examples the attack surface analysis system 114 can stop the addition of the tag specification into use, notify the submitting user and/or another user (e.g., an administrator), create an alert, etc.

Returning to FIG. 3, after the configuration of one or multiple tag specifications 116 with regard to circle (A) and the tag specifications 116 being provided to or made available to the orchestrator 306, at circle (B) the orchestrator 306 in some examples validates the provided tag specification 116. In some examples, the orchestrator 306 can ensure that any required attributes are present, and/or test the syntax of the tag specification 116 to ensure that it adheres to the requirements of the language that it is provided in. The orchestrator 306, in some examples, can additionally or alternatively perform a “test” run or evaluation of the tag specification, e.g., to ensure that it works and that any provided known targets are matched and that no provided known non-targets are matched. Other checks can similarly be performed to ensure that the tag specification is valid and doesn't cause problems. If any of these tests fail, the tag specification can be rejected from inclusion in the set of tag specifications that are evaluated, and the submitting user or an administrator can be notified of the issue, e.g., via configuration and reporting system 118. In some examples, the tag specification 116 is manually reviewed by a system administrator, though this may not be needed in some use cases. Thereafter, the tag specification 116 can thus made available for use (or “merged” into the system) by storing it in a data structure, such as a database, key-value store, or the like.

Accordingly, the attack surface management system 102 can perform operations to enable attack surface monitoring. In some examples, one or more data collection systems 112 of the attack surface management system 102 can operate to obtain source data 302 as reflected by circle (1). In some examples, data collection systems 112 can be installed or executed within one or more IT environments 150A-150N having potential targets, and the data collection systems 112 can operate to learn about the existence of targets. For example, the data collection system 112 can interact with various databases 320 that may exist that provide metadata about deployed assets (e.g., physical computing devices, virtual machines, services, applications, repositories, network equipment, etc.) or the like. As another example, the data collection system 112 can monitor network traffic to identify sources and destinations, send traffic to identify the existence of entities within the network (e.g., attempting to reach various available addresses within a network space), identify open or utilized network ports (e.g., via port-scanning type processes), etc. Additionally, or alternatively, the data collection system 112 can be directly configured by an administrator type persona with information to aid or assist in this discovery and monitoring, which may be a continual or periodic occurrence. Moreover, in some examples, the data collection system 112 can be deployed in other locations as well, such as within a cloud provider network 108, separate data center of an operator of the attack surface management system 102, within one or more other IT environments 150, etc.

Accordingly, the data collection system 112 can identify metadata associated with various targets, optionally normalize and/or “clean” the data to adhere to a desired format, and transmit it for storage to a set of source data 302 at circle (2). The source data 302 can be stored in a network-accessible repository such as a fileshare, cloud storage service location, or the like.

In some examples, the attack surface analysis system 114 can perform some or all of this cleansing or normalization as well, and optionally other data enrichment tasks such as aggregation, supplementation, etc., to contain addition information that can potentially be published for use (e.g., as attack surface data 304) by an analyst or software automation tool. For example, the attack surface analysis system 114 may use a DNS engine 308 to obtain DNS related information associated with a target, a discovery engine 310 to attempt to discover targets and information (e.g., such as within the provider network 108), one or more network scanners 312 to attempt to look for targets within a network, one or more web scanners 314 to attempt to look for targets and/or obtain additional information via HTTP-based communications, etc.

At this stage, or periodically based on a schedule or on an event-driven basis (such as the update of various source data 302), at circle (3) the attack surface analysis system 114 can evaluate the tag specifications 116 against a set of targets represented in the attack surface data 304 to perform automated target tagging.

For example, the orchestrator 306 can evaluate the tag specifications 116 against a data structure storing target information. This can be performed in an order based on a priority value of the tag specifications 116, such that those higher-priority tag specifications are evaluated first and lower-priority tag specifications are evaluated later. In other examples, such as those not using priority values, the tag specifications can be evaluated according to a different ordering mechanism, such as by a date of their submission (e.g., “older” ones processed first), alphabetically according to name, randomly, or the like.

As described, in some examples each tag specification can have zero to many match conditions specified. If a tag specification has zero conditions, it may exist simply for other tags to use to identify something helpful; if a tag specification has one or more conditions, the orchestrator 306 can search active targets based on those conditions (e.g., based on use of “AND” or “OR” logic). Additionally, as indicated, a tag specification may have zero to many associated tags, whereby the orchestrator 306 can potentially automatically apply multiple tags (including a “base” tag) to matching targets. Thus, when orchestrator 306 determines that a target matches the conditions for a tag, it can automatically apply that tag with any associated tags to the target. In some cases, it could be the case that multiple (e.g., twenty or more) different tag specifications may match a single target, thus providing a rich set of “target tags” that can be used by automated processes/systems and/or humans as part of investigation, testing, or remediation.

Based on these automated target tagging techniques, both humans and automations can quickly locate targets (objects) of interest by searching for a specific tag, or searching across all tags matched to a target by a search phrase. Moreover, in some examples, should human operators need to define a new tag for something they have never encountered before, the tag specification can be processed quickly using the attack surface data 304 data that the attack surface management system 102 has already recorded—thus, the attack surface does not need to be rescanned to take advantage of new tags, as the repository 110 likely already includes all necessary data needed for automated tagging of assets. Further, in some examples, historical attack surface data 304 can be maintained and analyzed to potentially apply tags to targets that may have only existed at previous points in time. For example, a security team can determine if the organization is currently exposed to a particular security exploit (e.g., that attacks a particular system or protocol) as well as identifying whether the organization was previously exposed to the exploit, even if the target no longer exists.

Accordingly, this attack surface data 304 including tags can be provided by the configuration and reporting system 118 to users 106 (e.g., via a web-based console), allowing for searching and querying and exploration of targets based on these tags. Additionally, or alternatively, attack surface data 304 can be provided to other systems 316A-316B by the configuration and reporting system 118, such as via APIs. Other systems 316A-316B could include a variety of computing systems and the data used for a variety of purposes, for example, a system 316A could be a SIEM application 226 that uses the tagging data or an OAR service 224 that may execute playbooks, for example, involving particular targets that have been tagged in a particular manner.

As described, tag specification 116 data can be provided in a variety of ways using a variety of formats. In some examples, a tag specification 116 is provided using an attack surface serialization language, which may be alphanumeric text in a file. As another example, a tag specification 116 can be provided in other ways, such as via use of a GUI.

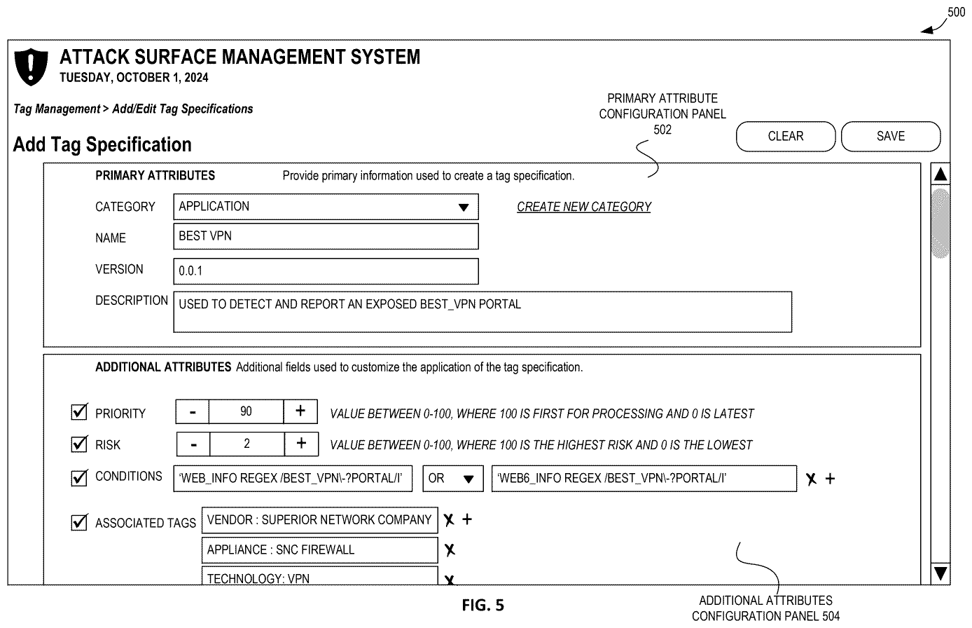

FIG. 5 illustrates an example graphical user interface 500 for obtaining user input for creating user-configured tag specifications according to some examples. In some examples, this GUI 500 is provided (or, data for the GUI 500 is provided) by the configuration and reporting system 118. For example, the GUI 500 can be provided as a web page within a browser or other application and thus the configuration and reporting system 118 may transmit web page data such as HyperText Markup Language (HTML), Cascading Style Sheets (CSS), JavaScript, or the like to cause the GUI 500 to be presented to a user. The user-configuration of a tag specification using this (or similar) interface may cause a response (e.g., in the form of a request to submit form data) to be sent to the configuration and reporting system 118. In other examples, the GUI 500 may be partially or completely provided by a software application executed locally on a client device, though the “submission” of the data within the interface can cause the user-configured data to be sent to the configuration and reporting system 118.

In this example, the GUI 500 provides various panels (502, 504) including user interface (UI) input elements allowing a user to provide configuration data for defining a tag specification. In some examples, a similar interface can be provided for allowing users to edit an existing tag specification, where current attribute values are pre-populated into the interface. Various UI input elements can be used to allow user input, as is known to those of skill in the art; thus, the particular displayed UI input elements are to be viewed as exemplary of one configuration. For example, UI input elements of varying types can be used such as drop down boxes, text input boxes, checkboxes, radio buttons, hyperlinks, sliders, combo boxes, accordion elements, breadcrumbs, carousels, charts, date pickers, multiselects, icons, toggles, etc.

As shown, the GUI 500 includes a primary attribute configuration panel 502 providing UI input elements allowing users to configure a first set of attributes. In this example, it may be the case that these primary attributes are required, though in other examples there may be different required attributes, fewer (or even no) required attributes, more required attributes, etc. However, as shown, the primary attribute configuration panel 502 seeks user input to configure a name for a tag specification, a category (e.g., by selecting one from a list of existing categories provided by a dropdown, or by creating a new category via selecting a link), a version number/identifier, and a description.

The GUI 500 also includes an additional attributes configuration panel 504 providing UI input elements allowing users to configure a second set of attributes. In some examples, these are optional attributes, though in other examples there may be different optional attributes, fewer (or even no) optional attributes, more optional attributes, etc. As shown, a portion of an additional attributes configuration panel 504 is illustrated, and thus other similar non-illustrated attributes can also be configured via such an interface, such as by scrolling down to view additional portions of the GUI. Here, the user is able to use checkbox UI input elements to indicate which, if any, attributes are to be included in a resultant tag specification. Here, a user has configured a priority attribute with a value of “90” indicating relatively early processing of the tag specification during an execution, a risk attribute with a value of “2” indicating relatively low risk associated with targets matched by this tag specification.

The additional attributes configuration panel 504 also includes a user configured set of conditions—here, a first condition and a second condition with an OR operator indicating that if either condition evaluates to true, then the tag specification is to be applied to the target and thus the target is to be tagged accordingly.

Additionally, the additional attributes configuration panel 504 also includes a user configured set of associated tags. In this example, three additional tags are configured by the user to also be associated with a matched target in addition to the primary tag (e.g., “Application:Best VPN”). These additional tags include “Vendor: Superior Network Company” and “Appliance:SNC Firewall” and “Technology:VPN”, allowing for a rich set of tags to be associated with a target, enabling different ways for users to “drill down” to find particular targets of interest and/or automations to work on different collections of targets based on some common tag.

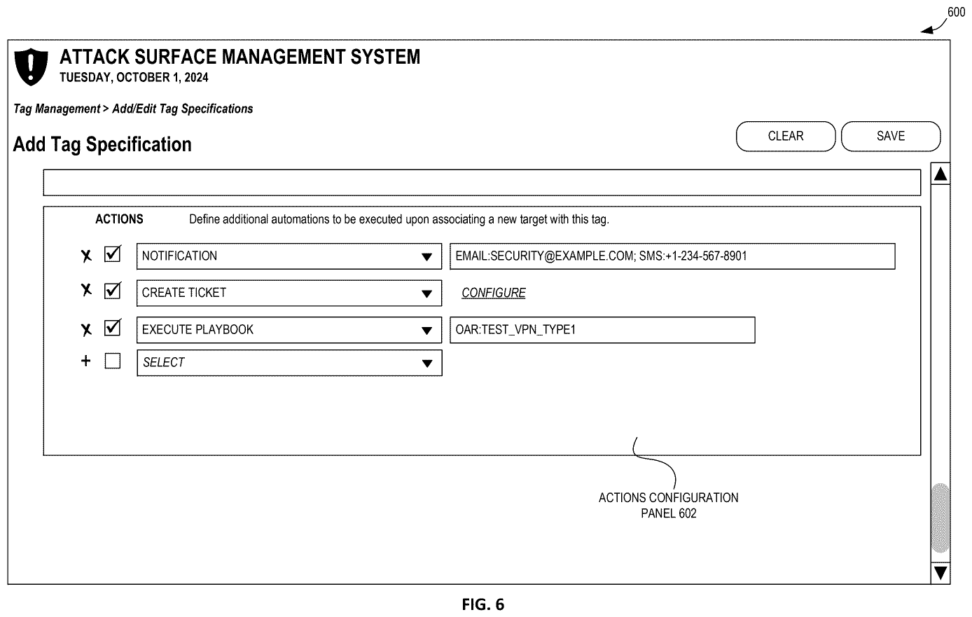

FIG. 6 illustrates other portions of an example graphical user interface for obtaining user input for configuring user-configured tag specifications according to some examples. In some examples, the attack surface analysis system 114 can provide such an interface to allow users to configure one or more automated actions to be performed responsive to detection of a new target that matches the tag specification. A variety of types of actions can be supported, such as sending electronic messages to notify other computing systems/services, messaging particular users, creating support or “tickets” or “tasks” for other users, causing a playbook to be executed, etc.

In this example, a user has added a “notification” action to send two notifications (here, via email and Short Message Service (SMS) communications, though other types of communication channels can be used such as voice call, application-specific messaging platform, or the like) via email and a SMS text message. The user has also configured a “ticket” to be created in an application such as a project management or issue tracking system, as well as the initiation of a playbook execution (e.g., provided by an OAR service described herein). Accordingly, upon the tag specification matching a target for the first time (or, in some examples, any time the tag specification matches a target), the attack surface analysis system 114 can perform these actions, such as by having the configuration and reporting system 118 send requests to other systems 316A-316B like an OAR service 224, SIEM application 226, data intake and query system 210, issue tracking system, email server or service, messaging server or service, or the like.

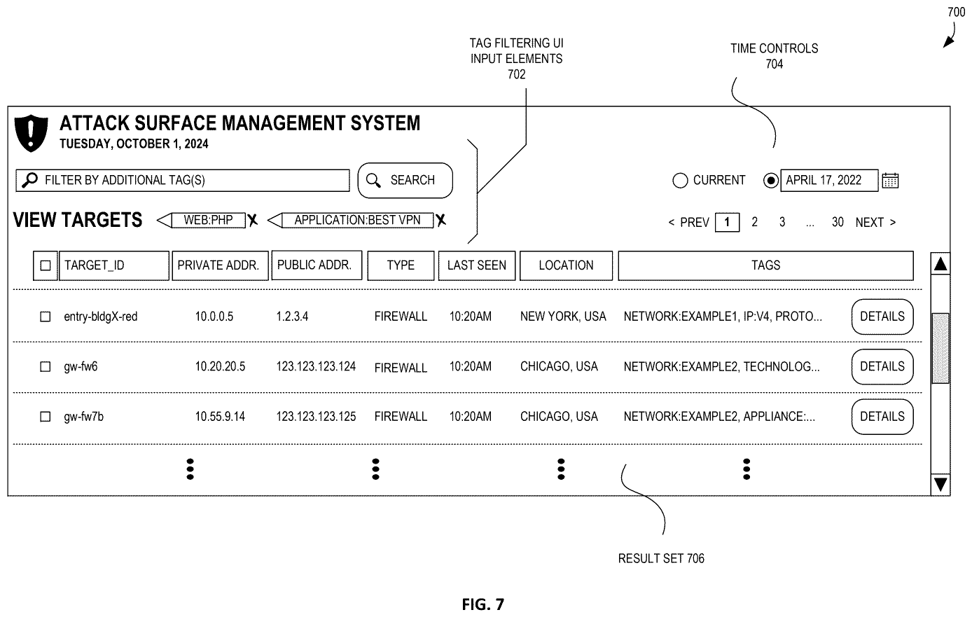

Various other user interfaces exist that can provide benefits through the use of automated tagging via tag specifications. FIG. 7 illustrates one such interface in the form of an example graphical user interface 700 for target exploration with tag visibility and filtering according to some examples. As indicated herein, by tagging targets in an automated manner, various tags can be quickly applied to targets, enabling systems and users to quickly be able to find targets of interest based on these tags. For example, GUI 700 presents a “view targets” type interface allowing users to search (or “filter”) a list of targets in an attack surface based on these tags, here using a collection of tag filtering UI input elements 702. Here, a user may type in or select a tag (from a list of tags) of interest, and the result set 706 interface can be updated to show those targets associated with the tag. In some examples, a user may “drill down” by entering one tag of interest (e.g., “Web:PHP” to find targets comprising web technologies utilizing PHP), examining the results, and then further filtering by adding further tags to further filter down the result set 706—here, by also filtering on those targets have an associated tag of “Application: Best VPN”. As shown, a result set 706 may include entries for some or all “matching” targets, here showing metadata such as a target identifier, a private network address of the asset, a public network address of the asset, a type of the target, a “last seen” date/time indicating a last observation of activity associated with that target, a physical or geographic location of the asset, a partial or complete set of tags associated with the target, etc.

This example interface also includes a set of time controls 704. In some examples, this GUI 700 may allow users to search and explore assets based on tags using only the “current” (or most recent) view of targets and tags. However, in some examples, the GUI 700 may also, or alternatively, allow a user to indicate a particular date or time of interest - here, by selecting a date. The attack surface analysis system 114 may then utilize historical records of what targets existed at a particular point in time (e.g., and then re-running the current tag specifications, or even the tag specifications at that point in time if desired) to show what the state of the attack surface was then. Accordingly, the attack surface analysis system 114 can allow users to determine the posture of the attack surface either currently or previously—the latter can be beneficially used to learn if (and when) the attack surface was exposed to a newly-discovered threat that only now has a tag specification created to identify affected resources, for example.

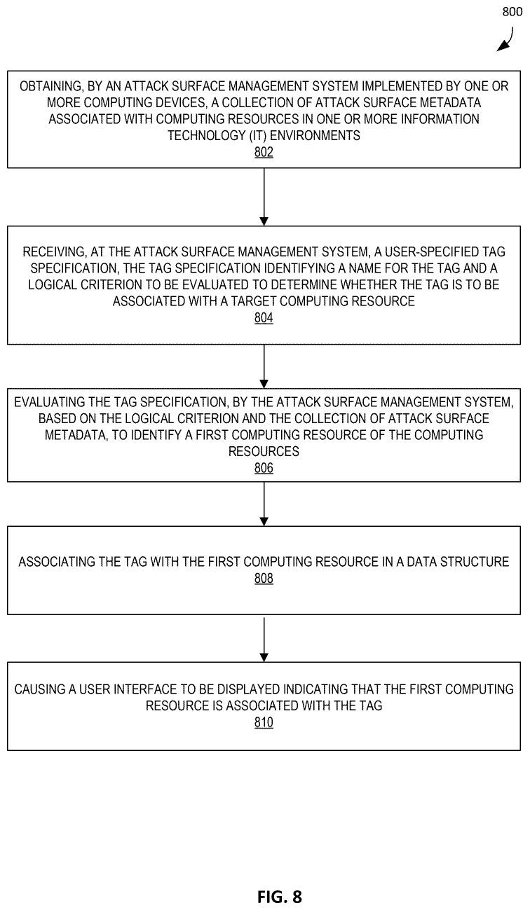

FIG. 8 is a flowchart illustrating operations 800 of an example process for automated attack surface target tagging using user-configured tag specifications according to some examples. The example process can be implemented, for example, by one or more computing devices each comprising one or more processors and a non-transitory computer-readable medium. The non-transitory computer readable medium can store instructions which, when executed by the one or more processors, can cause the one or more processors to perform the operations of the illustrated process. Alternatively, or additionally, the process can be implemented using a non-transitory computer-readable medium storing instructions that, when executed by one or more processors, cause the one or more processors to perform the operations of the process of FIG. 8. In some examples, the operations 800 are performed by an attack surface management system 102 of the other figures.

At block 802, the process 800 includes obtaining, by an attack surface management system implemented by one or more computing devices, a collection of attack surface metadata associated with computing resources in one or more information technology (IT) environments. The collection of attack surface metadata may be from or based on data collected by a data collection system deployed in one or more of the IT environments. The collection of attack surface metadata may be stored in a storage location (e.g., a directory, bucket, or the like) of an object storage service.

At block 804, the process 800 includes receiving, at the attack surface management system, a user-specified tag specification, the tag specification identifying a name for the tag and a logical criterion to be evaluated to determine whether the tag is to be associated with a target computing resource.

In some examples, the user-specified tag specification further includes a priority value indicative of when to process the tag specification relative to other tag specifications. In some examples, the user-specified tag specification further includes a risk value indicative of a risk severity associated with the tag that is applied to an associated computing resource.

In some examples, the user-specified tag specification further includes identifiers of one or more associated tags that are also to be associated with a target computing resource upon the logical criterion being satisfied for that target computing resource, and the operations further include associating the one or more associated tags with the first computing resource in the data structure, where the user interface further indicates that the one or more associated tags are also associated with the first computing resource.

In some examples, the user-specified tag specification further includes one or more uniform resource location (URL) path values, and the operations further include transmitting requests via use of the one or more URL path values to gather additional attack surface metadata. In some examples, the operations further include evaluating a second user-specified tag specification, after the evaluating of the tag specification, based on use of the additional attack surface metadata. The tag specification, in some examples, includes a first priority value; the second tag specification includes a second priority value that is different than the first priority value; and the second user-specified tag specification is evaluated after the tag specification based on the second priority value being larger or smaller than the first priority value.

In some examples, the user-specified tag specification further includes identifiers of one or more known targets, and the operations further include: determining that the user-specified tag specification, based on the logical criterion, does match each of the one or more known targets; and enabling the tag specification for use within the attack surface management system.

In some examples, the user-specified tag specification further includes identifiers of one or more known non-targets, and the operations further include determining that the user-specified tag specification, based on the logical criterion, does not match each of the one or more known non-targets; and enabling the tag specification for use within the attack surface management system.

In some examples, the logical criterion includes use of a regular expression or a logical comparison operator.

The operations 800 further include, in some examples, executing a user-selected action, associated with the user-specified tag specification, based on the identification of the first computing resource. In some examples, the tag specification is provided in a human-readable data serialization language.

The receiving of the user-specified tag specification, in some examples, comprises receiving a pull request, and the operations further include presenting the tag specification via a second user interface to a second user; and receiving a request originated on behalf of the second user to merge the user-specified tag specification into a collection of tag specifications utilized by the attack surface management system.

At block 806, the process 800 includes evaluating the tag specification, by the attack surface management system, based on the logical criterion and the collection of attack surface metadata, to identify a first computing resource of the computing resources. The evaluating may be part of a larger process, whereby multiple tag specifications are evaluated.

At block 808, the process 800 includes associating the tag with the first computing resource in a data structure. The data structure can be a database, a file, a key-value store, etc.

At block 810, the process 800 includes causing a user interface to be displayed indicating that the first computing resource is associated with the tag. The user interface may be a dashboard, a target search interface (e.g., akin to GUI 700), etc.

The operations 800 further include, in some examples, receiving a second tag specification, wherein the second tag specification identifies a second tag but does not include any logical criterion; evaluating the second tag specification prior to the evaluating of the tag specification, wherein the tag specification further includes an identifier of the second tag as being an associated tag for the tag specification; and after the evaluating of the tag specification, associating the second tag with the first computing resource in the data structure.

Entities of various types, such as companies, educational institutions, medical facilities, governmental departments, and private individuals, among other examples, operate computing environments for various purposes. Computing environments, which can also be referred to as IT environments, can include inter-networked, physical hardware devices, the software executing on the hardware devices, and the users of the hardware and software. As an example, an entity such as a school can operate a Local Area Network (LAN) that includes desktop computers, laptop computers, smart phones, and tablets connected to a physical and wireless network, where users correspond to teachers and students. In this example, the physical devices may be in buildings or a campus that is controlled by the school. As another example, an entity such as a business can operate a Wide Area Network (WAN) that includes physical devices in multiple geographic locations where the offices of the business are located. In this example, the different offices can be inter-networked using a combination of public networks such as the Internet and private networks. As another example, an entity can operate a data center: a centralized location where computing resources are kept and maintained, and whose resources are accessible over a network. In this example, users associated with the entity that operates the data center can access the computing resources in the data center over public and/or private networks that may not be operated and controlled by the same entity. Alternatively, or additionally, the operator of the data center may provide the computing resources to users associated with other entities, for example on a subscription basis. In both of these examples, users may expect resources to be available on demand and without direct active management by the user, a resource delivery model often referred to as cloud computing.

Entities that operate computing environments need information about their computing environments. For example, an entity may need to know the operating status of the various computing resources in the entity's computing environment, so that the entity can administer the environment, including performing configuration and maintenance, performing repairs or replacements, provisioning additional resources, removing unused resources, or addressing issues that may arise during operation of the computing environment, among other examples. As another example, an entity can use information about a computing environment to identify and remediate security issues that may endanger the data, users, and/or equipment in the computing environment. As another example, an entity may be operating a computing environment for some purpose (e.g., to run an online store, to operate a bank, to manage a municipal railway, etc.) and information about the computing environment can aid the entity in understanding whether the computing environment is serving its purpose well.

A data intake and query system can ingest and store data obtained from the components in a computing environment, and can enable an entity to search, analyze, and visualize the data. Through these and other capabilities, a data intake and query system can enable an entity to use the data for administration of the computing environment, to detect security issues, to understand how the computing environment is performing or being used, and/or to perform other analytics.

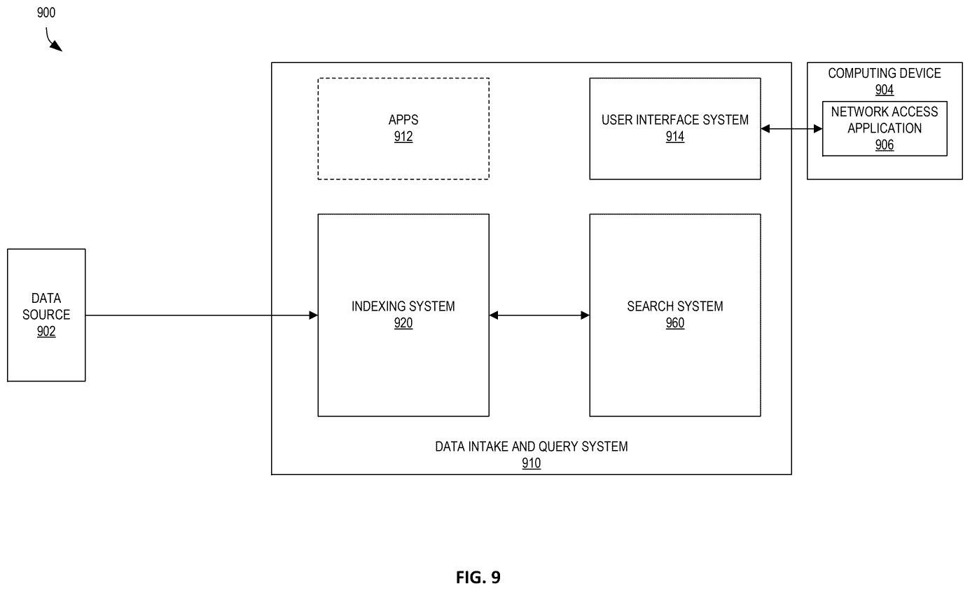

FIG. 9 is a block diagram illustrating an example computing environment 900 that includes a data intake and query system 910. The data intake and query system 910 obtains data from a data source 902 in the computing environment 900 and ingests the data using an indexing system 920. A search system 960 of the data intake and query system 910 enables users to navigate the indexed data. Though drawn with separate boxes, in some implementations the indexing system 920 and the search system 960 can have overlapping components. A computing device 904, running a network access application 906, can communicate with the data intake and query system 910 through a user interface system 914 of the data intake and query system 910. Using the computing device 904, a user can perform various operations with respect to the data intake and query system 910, such as administration of the data intake and query system 910, management and generation of “knowledge objects,” initiating of searches, and generation of reports, among other operations. The data intake and query system 910 can further optionally include apps 912 that extend the search, analytics, and/or visualization capabilities of the data intake and query system 910.

The data intake and query system 910 can be implemented using program code that can be executed using a computing device. A computing device is an electronic device that has a memory for storing program code instructions and a hardware processor for executing the instructions. The computing device can further include other physical components, such as a network interface or components for input and output. The program code for the data intake and query system 910 can be stored on a non-transitory computer-readable medium, such as a magnetic or optical storage disk or a flash or solid-state memory, from which the program code can be loaded into the memory of the computing device for execution. “Non-transitory” means that the computer-readable medium can retain the program code while not under power, as opposed to volatile or “transitory” memory or media that requires power in order to retain data.

In various examples, the program code for the data intake and query system 910 can execute on a single computing device, or may be distributed over multiple computing devices. For example, the program code can include instructions for executing both indexing and search components (which may be part of the indexing system 920 and/or the search system 960, respectively), and can be executed on a computing device that also provides the data source 902. As another example, the program code can execute on one computing device, where the program code executes both indexing and search components, while another copy of the program code executes on a second computing device that provides the data source 902. As another example, the program code can execute only an indexing component or only a search component. In this example, a first instance of the program code that is executing the indexing component and a second instance of the program code that is executing the search component can be executing on the same computing device or on different computing devices.

The data source 902 of the computing environment 900 is a component of a computing device that produces machine data. The component can be a hardware component (e.g., a microprocessor or a network adapter, among other examples) or a software component (e.g., a part of the operating system or an application, among other examples). The component can be a virtual component, such as a virtual machine, a virtual machine monitor (also referred as a hypervisor), a container, or a container orchestrator, among other examples. Examples of computing devices that can provide the data source 902 include personal computers (e.g., laptops, desktop computers, etc.), handheld devices (e.g., smart phones, tablet computers, etc.), servers (e.g., network servers, compute servers, storage servers, domain name servers, web servers, etc.), network infrastructure devices (e.g., routers, switches, firewalls, etc.), and “Internet of Things” devices (e.g., vehicles, home appliances, factory equipment, etc.), among other examples. Machine data is electronically generated data that is output by the component of the computing device and reflects activity of the component. Such activity can include, for example, operation status, actions performed, performance metrics, communications with other components, or communications with users, among other examples. The component can produce machine data in an automated fashion (e.g., through the ordinary course of being powered on and/or executing) and/or as a result of user interaction with the computing device (e.g., through the user's use of input/output devices or applications). The machine data can be structured, semi-structured, and/or unstructured. The machine data may be referred to as raw machine data when the data is unaltered from the format in which the data was output by the component of the computing device. Examples of machine data include operating system logs, web server logs, live application logs, network feeds, metrics, change monitoring, message queues, and archive files, among other examples.

As discussed in greater detail below, the indexing system 920 obtains machine date from the data source 902 and processes and stores the data. Processing and storing of data may be referred to as “ingestion” of the data. Processing of the data can include parsing the data to identify individual events, where an event is a discrete portion of machine data that can be associated with a timestamp. Processing of the data can further include generating an index of the events, where the index is a data storage structure in which the events are stored. The indexing system 920 does not require prior knowledge of the structure of incoming data (e.g., the indexing system 920 does not need to be provided with a schema describing the data). Additionally, the indexing system 920 retains a copy of the data as it was received by the indexing system 920 such that the original data is always available for searching (e.g., no data is discarded, though, in some examples, the indexing system 920 can be configured to do so).

The search system 960 searches the data stored by the indexing 920 system. As discussed in greater detail below, the search system 960 enables users associated with the computing environment 900 (and possibly also other users) to navigate the data, generate reports, and visualize results in “dashboards” output using a graphical interface. Using the facilities of the search system 960, users can obtain insights about the data, such as retrieving events from an index, calculating metrics, searching for specific conditions within a rolling time window, identifying patterns in the data, and predicting future trends, among other examples. To achieve greater efficiency, the search system 960 can apply map-reduce methods to parallelize searching of large volumes of data. Additionally, because the original data is available, the search system 960 can apply a schema to the data at search time. This allows different structures to be applied to the same data, or for the structure to be modified if or when the content of the data changes. Application of a schema at search time may be referred to herein as a late-binding schema technique.

The user interface system 914 provides mechanisms through which users associated with the computing environment 900 (and possibly others) can interact with the data intake and query system 910. These interactions can include configuration, administration, and management of the indexing system 920, initiation and/or scheduling of queries to the search system 960, receipt or reporting of search results, and/or visualization of search results. The user interface system 914 can include, for example, facilities to provide a command line interface or a web-based interface.

Users can access the user interface system 914 using a computing device 904 that communicates with data intake and query system 910, possibly over a network. A “user,” in the context of the implementations and examples described herein, is a digital entity that is described by a set of information in a computing environment. The set of information can include, for example, a user identifier, a username, a password, a user account, a set of authentication credentials, a token, other data, and/or a combination of the preceding. Using the digital entity that is represented by a user, a person can interact with the computing environment 900. For example, a person can log in as a particular user and, using the user's digital information, can access the data intake and query system 910. A user can be associated with one or more people, meaning that one or more people may be able to use the same user's digital information. For example, an administrative user account may be used by multiple people who have been given access to the administrative user account. Alternatively, or additionally, a user can be associated with another digital entity, such as a bot (e.g., a software program that can perform autonomous tasks). A user can also be associated with one or more entities. For example, a company can have associated with it a number of users. In this example, the company may control the users'digital information, including assignment of user identifiers, management of security credentials, control of which persons are associated with which users, and so on.

The computing device 904 can provide a human-machine interface through which a person can have a digital presence in the computing environment 900 in the form of a user. The computing device 904 is an electronic device having one or more processors and a memory capable of storing instructions for execution by the one or more processors. The computing device 904 can further include input/output (I/O) hardware and a network interface. Applications executed by the computing device 904 can include a network access application 906, which can a network interface of the client computing device 904 to communicate, over a network, with the user interface system 914 of the data intake and query system 910. The user interface system 914 can use the network access application 906 to generate user interfaces that enable a user to interact with the data intake and query system 910. A web browser is one example of a network access application. A shell tool can also be used as a network access application. In some examples, the data intake and query system 910 is an application executed on the computing device. In such examples, the network access application 906 can access the user interface system 914 without needing to go over a network.

The data intake and query system 910 can optionally include apps 912. An app of the data intake and query system 910 is a collection of configurations, knowledge objects (a user-defined entity that enriches the data in the data intake and query system 910), views, and dashboards that may provide additional functionality, different techniques for searching the data, and/or additional insights into the data. The data intake and query system 910 can execute multiple applications simultaneously. Example applications include an IT service intelligence application, which can monitor and analyze the performance and behavior of the computing environment 900, and a security application, which can include content and searches to assist security analysts in diagnosing and acting on anomalous or malicious behavior in the computing environment 900.

Though FIG. 9 illustrates only one data source, in practical implementations, the computing environment 900 contains many data sources spread across numerous computing devices. The computing devices may be controlled and operated by a single entity. For example, in an “on the premises” or “on-prem” implementation, the computing devices may physically and digitally be controlled by one entity, meaning that the computing devices are in physical locations that are owned and/or operated by the entity and are within a network domain that is controlled by the entity. In an entirely on-prem implementation of computing environment 900, the data intake and query system 910 executes on an on-prem computing device and obtains machine data from on-prem data sources. An on-prem implementation can also be referred to as an “enterprise” network, though the term “on-prem” refers primarily to physical locality of a network and who controls that location while the term “enterprise” may be used to refer to the network of a single entity. As such, an enterprise network could include cloud components.

“Cloud” or “in the cloud” refers to a network model in which an entity operates network resources (e.g., processor capacity, network capacity, storage capacity, etc.), located for example in a data center, and makes those resources available to users and/or other entities over a network. A “private cloud” is a cloud implementation where the entity provides the network resources only to its own users. A “public cloud” is a cloud implementation where an entity operates network resources in order to provide them to users that are not associated with the entity and/or to other entities. In this implementation, the provider entity can, for example, allow a subscriber entity to pay for a subscription that enables users associated with subscriber entity to access a certain amount of the provider entity's cloud resources, possibly for a limited time. A subscriber entity of cloud resources can also be referred to as a tenant of the provider entity. Users associated with the subscriber entity access the cloud resources over a network, which may include the public Internet. In contrast to an on-prem implementation, a subscriber entity does not have physical control of the computing devices that are in the cloud and has digital access to resources provided by the computing devices only to the extent that such access is enabled by the provider entity.

In some implementations, the computing environment 900 can include on-prem and cloud-based computing resources, or only cloud-based resources. For example, an entity may have on-prem computing devices and a private cloud. In this example, the entity operates the data intake and query system 910 and can choose to execute the data intake and query system 910 on an on-prem computing device or in the cloud. In another example, a provider entity operates the data intake and query system 910 in a public cloud and provides the functionality of the data intake and query system 910 as a service, for example under a Software-as-a-Service (SaaS) model. In this example, the provider entity can provision a separate tenant (or possibly multiple tenants) in the public cloud network for each subscriber entity, where each tenant executes a separate and distinct instance of the data intake and query system 910. In some implementations, the entity providing the data intake and query system 910 is itself subscribing to the cloud services of a cloud service provider. As an example, a first entity provides computing resources under a public cloud service model, a second entity subscribes to the cloud services of the first provider entity and uses the cloud computing resources to operate the data intake and query system 910, and a third entity can subscribe to the services of the second provider entity to use the functionality of the data intake and query system 910. In this example, the data sources are associated with the third entity, users accessing the data intake and query system 910 are associated with the third entity, and the analytics and insights provided by the data intake and query system 910 are for purposes of the third entity's operations.

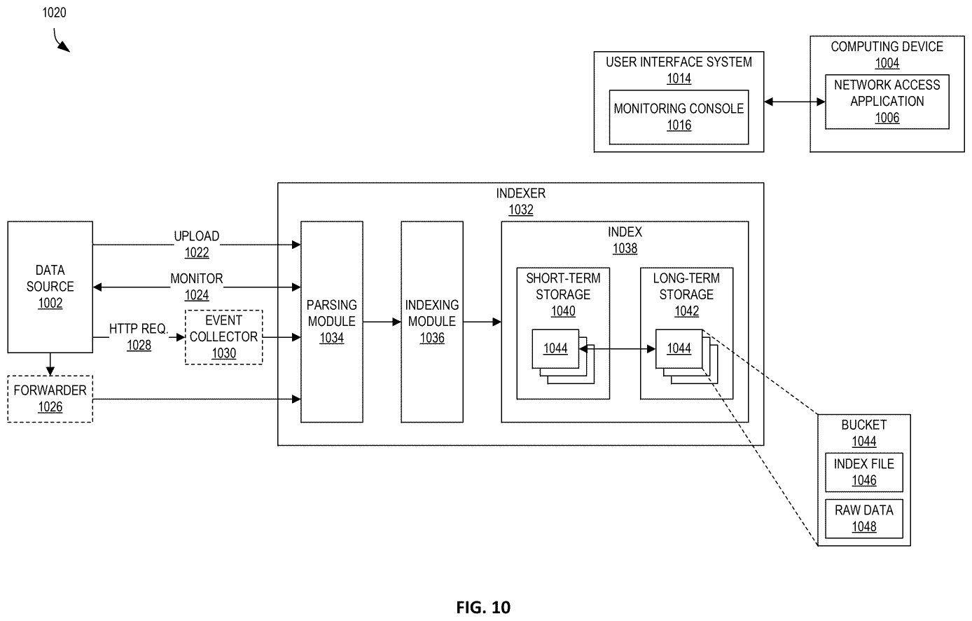

FIG. 10 is a block diagram illustrating in greater detail an example of an indexing system 1020 of a data intake and query system, such as the data intake and query system 910 of FIG. 9. The indexing system 1020 of FIG. 10 uses various methods to obtain machine data from a data source 1002 and stores the data in an index 1038 of an indexer 1032. As discussed previously, a data source is a hardware, software, physical, and/or virtual component of a computing device that produces machine data in an automated fashion and/or as a result of user interaction. Examples of data sources include files and directories; network event logs; operating system logs, operational data, and performance monitoring data; metrics; first-in, first-out queues; scripted inputs; and modular inputs, among others. The indexing system 1020 enables the data intake and query system to obtain the machine data produced by the data source 1002 and to store the data for searching and retrieval.

Users can administer the operations of the indexing system 1020 using a computing device 1004 that can access the indexing system 1020 through a user interface system 1014 of the data intake and query system. For example, the computing device 1004 can be executing a network access application 1006, such as a web browser or a terminal, through which a user can access a monitoring console 1016 provided by the user interface system 1014. The monitoring console 1016 can enable operations such as: identifying the data source 1002 for indexing; configuring the indexer 1032 to index the data from the data source 1002; configuring a data ingestion method; configuring, deploying, and managing clusters of indexers; and viewing the topology and performance of a deployment of the data intake and query system, among other operations. The operations performed by the indexing system 1020 may be referred to as “index time” operations, which are distinct from “search time” operations that are discussed further below.

The indexer 1032, which may be referred to herein as a data indexing component, coordinates and performs most of the index time operations. The indexer 1032 can be implemented using program code that can be executed on a computing device. The program code for the indexer 1032 can be stored on a non-transitory computer-readable medium (e.g. a magnetic, optical, or solid-state storage disk, a flash memory, or another type of non-transitory storage media), and from this medium can be loaded or copied to the memory of the computing device. One or more hardware processors of the computing device can read the program code from the memory and execute the program code in order to implement the operations of the indexer 1032. In some implementations, the indexer 1032 executes on the computing device 1004 through which a user can access the indexing system 1020. In some implementations, the indexer 1032 executes on a different computing device.

The indexer 1032 may be executing on the computing device that also provides the data source 1002 or may be executing on a different computing device. In implementations wherein the indexer 1032 is on the same computing device as the data source 1002, the data produced by the data source 1002 may be referred to as “local data.” In other implementations the data source 1002 is a component of a first computing device and the indexer 1032 executes on a second computing device that is different from the first computing device. In these implementations, the data produced by the data source 1002 may be referred to as “remote data.” In some implementations, the first computing device is “on-prem” and in some implementations the first computing device is “in the cloud.” In some implementations, the indexer 1032 executes on a computing device in the cloud and the operations of the indexer 1032 are provided as a service to entities that subscribe to the services provided by the data intake and query system.

For a given data produced by the data source 1002, the indexing system 1020 can be configured to use one of several methods to ingest the data into the indexer 1032. These methods include upload 1022, monitor 1024, using a forwarder 1026, or using HTTP 1028 and an event collector 1030. These and other methods for data ingestion may be referred to as “getting data in” (GDI) methods.

Using the upload 1022 method, a user can instruct the indexing system to 1002 to specify a file for uploading into the indexer 1032. For example, the monitoring console 1016 can include commands or an interface through which the user can specify where the file is located (e.g., on which computing device and/or in which directory of a file system) and the name of the file. Once uploading is initiated, the indexer 1032 processes the file, as discussed further below. Uploading is a manual process and occurs when instigated by a user. For automated data ingestion, the other ingestion methods are used.

The monitor 1024 method enables the indexing system to monitor the data source 1002 and continuously or periodically obtain data produced by the data source 1002 for ingestion by the indexer 1032. For example, using the monitoring console 1016, a user can specify a file or directory for monitoring. In this example, the indexing system can execute a monitoring process that detects whenever data is added to the file or directory and causes the data to be sent to the indexer 1032. As another example, a user can specify a network port for monitoring. In this example, a monitoring process can capture data received at or transmitting from the network port and cause the data to be sent to the indexer 1032. In various examples, monitoring can also be configured for data sources such as operating system event logs, performance data generated by an operating system, operating system registries, operating system directory services, and other data sources.

Monitoring is available when the data source 1002 is local to the indexer 1032 (e.g., the data source 1002 is on the computing device where the indexer 1032 is executing). Other data ingestion methods, including forwarding and the event collector 1030, can be used for either local or remote data sources.

A forwarder 1026, which may be referred to herein as a data forwarding component, is a software process that sends data from the data source 1002 to the indexer 1032. The forwarder 1026 can be implemented using program code that can be executed on the computer device that provides the data source 1002. A user launches the program code for the forwarder 1026 on the computing device that provides the data source 1002. The user can further configure the program code, for example to specify a receiver for the data being forwarded (e.g., one or more indexers, another forwarder, and/or another recipient system), to enable or disable data forwarding, and to specify a file, directory, network events, operating system data, or other data to forward, among other operations.

The forwarder 1026 can provide various capabilities. For example, the forwarder 1026 can send the data unprocessed or can perform minimal processing on the data. Minimal processing can include, for example, adding metadata tags to the data to identify a source, source type, and/or host, among other information, dividing the data into blocks, and/or applying a timestamp to the data. In some implementations, the forwarder 1026 can break the data into individual events (event generation is discussed further below) and send the events to a receiver. Other operations that the forwarder 1026 may be configured to perform include buffering data, compressing data, and using secure protocols for sending the data, for example.

Forwarders can be configured in various topologies. For example, multiple forwarders can send data to the same indexer. As another example, a forwarder can be configured to filter and/or route events to specific receivers (e.g., different indexers), and/or discard events. As another example, a forwarder can be configured to send data to another forwarder, or to a receiver that is not an indexer or a forwarder (such as, for example, a log aggregator).

The event collector 1030 provides an alternate method for obtaining data from the data source 1002. The event collector 1030 enables data and application events to be sent to the indexer 1032 using HTTP 1028. The event collector 1030 can be implemented using program code that can be executing on a computing device. The program code may be a component of the data intake and query system or can be a standalone component that can be executed independently of the data intake and query system and operates in cooperation with the data intake and query system.

To use the event collector 1030, a user can, for example using the monitoring console 1016 or a similar interface provided by the user interface system 1014, enable the event collector 1030 and configure an authentication token. In this context, an authentication token is a piece of digital data generated by a computing device, such as a server, that contains information to identify a particular entity, such as a user or a computing device, to the server. The token will contain identification information for the entity (e.g., an alphanumeric string that is unique to each token) and a code that authenticates the entity with the server. The token can be used, for example, by the data source 1002 as an alternative method to using a username and password for authentication.

To send data to the event collector 1030, the data source 1002 is supplied with a token and can then send HTTP requests 1028 to the event collector 1030. To send HTTP requests 1028, the data source 1002 can be configured to use an HTTP client and/or to use logging libraries such as those supplied by Java, JavaScript, and . NET libraries. An HTTP client enables the data source 1002 to send data to the event collector 1030 by supplying the data, and a Uniform Resource Identifier (URI) for the event collector 1030 to the HTTP client. The HTTP client then handles establishing a connection with the event collector 1030, transmitting a request containing the data, closing the connection, and receiving an acknowledgment if the event collector 1030 sends one. Logging libraries enable HTTP requests 1028 to the event collector 1030 to be generated directly by the data source. For example, an application can include or link a logging library, and through functionality provided by the logging library manage establishing a connection with the event collector 1030, transmitting a request, and receiving an acknowledgement.

An HTTP request 1028 to the event collector 1030 can contain a token, a channel identifier, event metadata, and/or event data. The token authenticates the request with the event collector 1030. The channel identifier, if available in the indexing system 1020, enables the event collector 1030 to segregate and keep separate data from different data sources. The event metadata can include one or more key-value pairs that describe the data source 1002 or the event data included in the request. For example, the event metadata can include key-value pairs specifying a timestamp, a hostname, a source, a source type, or an index where the event data should be indexed. The event data can be a structured data object, such as a JavaScript Object Notation (JSON) object, or raw text. The structured data object can include both event data and event metadata. Additionally, one request can include event data for one or more events.

In some implementations, the event collector 1030 extracts events from HTTP requests 1028 and sends the events to the indexer 1032. The event collector 1030 can further be configured to send events or event data to one or more indexers. Extracting the events can include associating any metadata in a request with the event or events included in the request. In these implementations, event generation by the indexer 1032 (discussed further below) is bypassed, and the indexer 1032 moves the events directly to indexing. In some implementations, the event collector 1030 extracts event data from a request and outputs the event data to the indexer 1032, and the indexer generates events from the event data. In some implementations, the event collector 1030 sends an acknowledgement message to the data source 1002 to indicate that the event collector 1030 has received a particular request form the data source 1002, and/or to indicate to the data source 1002 that events in the request have been added to an index.

The indexer 1032 ingests incoming data and transforms the data into searchable knowledge in the form of events. In the data intake and query system, an event is a single piece of data that represents activity of the component represented in FIG. 10 by the data source 1002. An event can be, for example, a single record in a log file that records a single action performed by the component (e.g., a user login, a disk read, transmission of a network packet, etc.). An event includes one or more fields that together describe the action captured by the event, where a field is a key-value pair (also referred to as a name-value pair). In some cases, an event includes both the key and the value, and in some cases the event includes only the value and the key can be inferred or assumed.

Transformation of data into events can include event generation and event indexing. Event generation includes identifying each discrete piece of data that represents one event and associating each event with a timestamp and possibly other information (which may be referred to herein as metadata). Event indexing includes storing of each event in the data structure of an index. As an example, the indexer 1032 can include a parsing module 1034 and an indexing module 1036 for generating and storing the events. The parsing module 1034 and indexing module 1036 can be modular and pipelined, such that one component can be operating on a first set of data while the second component is simultaneously operating on a second sent of data. Additionally, the indexer 1032 may at any time have multiple instances of the parsing module 1034 and indexing module 1036, with each set of instances configured to simultaneously operate on data from the same data source or from different data sources. The parsing module 1034 and indexing module 1036 are illustrated to facilitate discussion, with the understanding that implementations with other components are possible to achieve the same functionality.

The parsing module 1034 determines information about event data, where the information can be used to identify events within the event data. For example, the parsing module 1034 can associate a source type with the event data. A source type identifies the data source 1002 and describes a possible data structure of event data produced by the data source 1002. For example, the source type can indicate which fields to expect in events generated at the data source 1002 and the keys for the values in the fields, and possibly other information such as sizes of fields, an order of the fields, a field separator, and so on. The source type of the data source 1002 can be specified when the data source 1002 is configured as a source of event data. Alternatively, the parsing module 1034 can determine the source type from the event data, for example from an event field or using machine learning.

Other information that the parsing module 1034 can determine includes timestamps. In some cases, an event includes a timestamp as a field, and the timestamp indicates a point in time when the action represented by the event occurred or was recorded by the data source 1002 as event data. In these cases, the parsing module 1034 may be able to determine from the source type associated with the event data that the timestamps can be extracted from the events themselves. In some cases, an event does not include a timestamp and the parsing module 1034 determines a timestamp for the event, for example from a name associated with the event data from the data source 1002 (e.g., a file name when the event data is in the form of a file) or a time associated with the event data (e.g., a file modification time). As another example, when the parsing module 1034 is not able to determine a timestamp from the event data, the parsing module 1034 may use the time at which it is indexing the event data. As another example, the parsing module 1034 can use a user-configured rule to determine the timestamps to associate with events.

The parsing module 1034 can further determine event boundaries. In some cases, a single line (e.g., a sequence of characters ending with a line termination) in event data represents one event while in other cases, a single line represents multiple events. In yet other cases, one event may span multiple lines within the event data. The parsing module 1034 may be able to determine event boundaries from the source type associated with the event data, for example from a data structure indicated by the source type. In some implementations, a user can configure rules the parsing module 1034 can use to identify event boundaries.

The parsing module 1034 can further extract data from events and possibly also perform transformations on the events. For example, the parsing module 1034 can extract a set of fields for each event, such as a host or hostname, source or source name, and/or source type. The parsing module 1034 may extract certain fields by default or based on a user configuration. Alternatively or additionally, the parsing module 1034 may add fields to events, such as a source type or a user-configured field. As another example of a transformation, the parsing module 1034 can anonymize fields in events to mask sensitive information, such as social security numbers or account numbers. Anonymizing fields can include changing or replacing values of specific fields. The parsing module 1034 can further perform user-configured transformations.

The parsing module 1034 outputs the results of processing incoming event data to the indexing module 1036, which performs event segmentation and builds index data structures.

Event segmentation identifies searchable segments, which may alternatively be referred to as searchable terms or keywords, which can be used by the search system of the data intake and query system to search the event data. A searchable segment may be a part of a field in an event or an entire field. The indexer 1032 can be configured to identify searchable segments that are parts of fields, searchable segments that are entire fields, or both. The parsing module 1034 organizes the searchable segments into a lexicon or dictionary for the event data, with the lexicon including each searchable segment and a reference to the location of each occurrence of the searchable segment within the event data. As discussed further below, the search system can use the lexicon, which is stored in an index file 1046, to find event data that matches a search query. In some implementations, segmentation can alternatively be performed by the forwarder 1026. Segmentation can also be disabled, in which case the indexer 1032 will not build a lexicon for the event data. When segmentation is disabled, the search system searches the event data directly.

Building index data structures generates the index 1038. The index 1038 is a storage data structure on a storage device (e.g., a disk drive or other physical device for storing digital data). The storage device may be a component of the computing device on which the indexer 1032 is operating (referred to herein as local storage) or may be a component of a different computing device (referred to herein as remote storage) that the index 1038 has access to over a network. The indexer 1032 can include more than one index and can include indexes of different types. For example, the indexer 1032 can include event indexes, which impose minimal structure on stored data and can accommodate any type of data. As another example, the indexer 1032 can include metrics indexes, which use a highly structured format to handle the higher volume and lower latency demands associated with metrics data.

The indexing module 1036 organizes files in the index 1038 in directories referred to as buckets. The files in a bucket 1044 can include raw data files, index files, and possibly also other metadata files. As used herein, “raw data” means data as when the data was produced by the data source 1002, without alteration to the format or content. As noted previously, the parsing module 1034 may add fields to event data and/or perform transformations on fields in the event data, and thus a raw data file 1048 can include, in addition to or instead of raw data, what is referred to herein as enriched raw data. The raw data file 1048 may be compressed to reduce disk usage. An index file 1046, which may also be referred to herein as a “time-series index” or tsidx file, contains metadata that the indexer 1032 can use to search a corresponding raw data file 1048. As noted above, the metadata in the index file 1046 includes a lexicon of the event data, which associates each unique keyword in the event data in the raw data file 1048 with a reference to the location of event data within the raw data file 1048. The keyword data in the index file 1046 may also be referred to as an inverted index. In various implementations, the data intake and query system can use index files for other purposes, such as to store data summarizations that can be used to accelerate searches.

A bucket 1044 includes event data for a particular range of time. The indexing module 1036 arranges buckets in the index 1038 according to the age of the buckets, such that buckets for more recent ranges of time are stored in short-term storage 1040 and buckets for less recent ranges of time are stored in long-term storage 1042. Short-term storage 1040 may be faster to access while long-term storage 1042 may be slower to access. Buckets may move from short-term storage 1040 to long-term storage 1042 according to a configurable data retention policy, which can indicate at what point in time a bucket is old enough to be moved.

A bucket's location in short-term storage 1040 or long-term storage 1042 can also be indicated by the bucket's status. As an example, a bucket's status can be “hot,” “warm,” “cold,” “frozen,” or “thawed.” In this example, hot bucket is one to which the indexer 1032 is writing data and the bucket becomes a warm bucket when the index 1038 stops writing data to it. In this example, both hot and warm buckets reside in short-term storage 1040. Continuing this example, when a warm bucket is moved to long-term storage 1042, the bucket becomes a cold bucket. A cold bucket can become a frozen bucket after a period of time, at which point the bucket may be deleted or archived. An archived bucket cannot be searched. When an archived bucket is retrieved for searching, the bucket becomes thawed and can then be searched.

The indexing system 1020 can include more than one indexer, where a group of indexers is referred to as an index cluster. The indexers in an index cluster may also be referred to as peer nodes. In an index cluster, the indexers are configured to replicate each other's data by copying buckets from one indexer to another. The number of copies of a bucket can be configured (e.g., three copies of each bucket must exist within the cluster), and indexers to which buckets are copied may be selected to optimize distribution of data across the cluster.

A user can view the performance of the indexing system 1020 through the monitoring console 1016 provided by the user interface system 1014. Using the monitoring console 1016, the user can configure and monitor an index cluster, and see information such as disk usage by an index, volume usage by an indexer, index and volume size over time, data age, statistics for bucket types, and bucket settings, among other information.

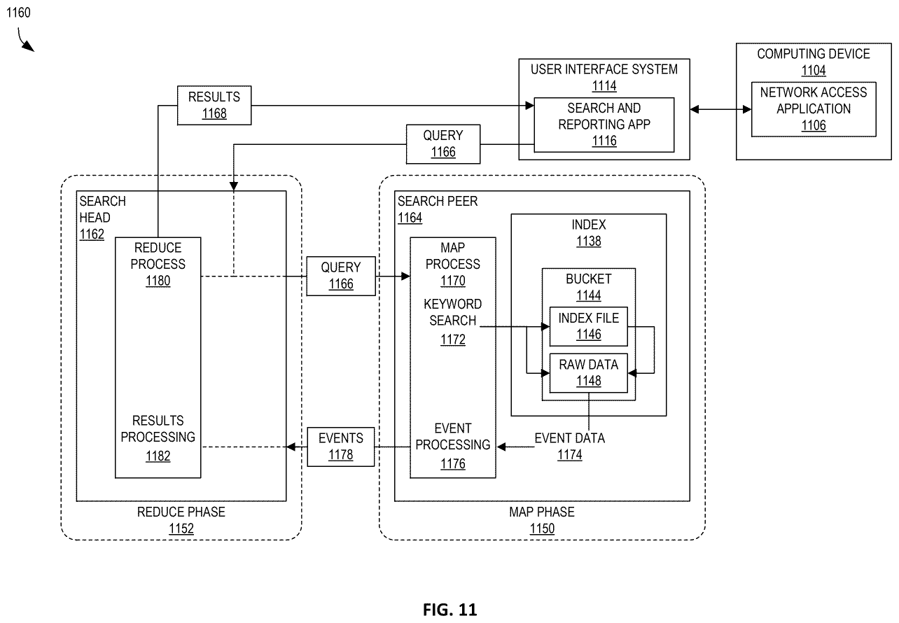

FIG. 11 is a block diagram illustrating in greater detail an example of the search system 1160 of a data intake and query system, such as the data intake and query system 910 of FIG. 9. The search system 1160 of FIG. 11 issues a query 1166 to a search head 1162, which sends the query 1166 to a search peer 1164. Using a map process 1170, the search peer 1164 searches the appropriate index 1138 for events identified by the query 1166 and sends events 1178 so identified back to the search head 1162. Using a reduce process 1182, the search head 1162 processes the events 1178 and produces results 1168 to respond to the query 1166. The results 1168 can provide useful insights about the data stored in the index 1138. These insights can aid in the administration of information technology systems, in security analysis of information technology systems, and/or in analysis of the development environment provided by information technology systems.

The query 1166 that initiates a search is produced by a search and reporting app 1116 that is available through the user interface system 1114 of the data intake and query system. Using a network access application 1106 executing on a computing device 1104, a user can input the query 1166 into a search field provided by the search and reporting app 1116. Alternatively, or additionally, the search and reporting app 1116 can include pre-configured queries or stored queries that can be activated by the user. In some cases, the search and reporting app 1116 initiates the query 1166 when the user enters the query 1166. In these cases, the query 1166 may be referred to as an “ad-hoc” query. In some cases, the search and reporting app 1116 initiates the query 1166 based on a schedule. For example, the search and reporting app 1116 can be configured to execute the query 1166 once per hour, once per day, at a specific time, on a specific date, or at some other time that can be specified by a date, time, and/or frequency. These types of queries may be referred to as scheduled queries.

The query 1166 is specified using a search processing language. The search processing language includes commands that the search peer 1164 will use to identify events to return in the search results 1168. The search processing language can further include commands for filtering events, extracting more information from events, evaluating fields in events, aggregating events, calculating statistics over events, organizing the results, and/or generating charts, graphs, or other visualizations, among other examples. Some search commands may have functions and arguments associated with them, which can, for example, specify how the commands operate on results and which fields to act upon. The search processing language may further include constructs that enable the query 1166 to include sequential commands, where a subsequent command may operate on the results of a prior command. As an example, sequential commands may be separated in the query 1166 by a vertical line (“|” or “pipe”) symbol.

In addition to one or more search commands, the query 1166 includes a time indicator. The time indicator limits searching to events that have timestamps described by the indicator. For example, the time indicator can indicate a specific point in time (e.g., 10:00:00 am today), in which case only events that have the point in time for their timestamp will be searched. As another example, the time indicator can indicate a range of time (e.g., the last 24 hours), in which case only events whose timestamps fall within the range of time will be searched. The time indicator can alternatively indicate all of time, in which case all events will be searched.

Processing of the search query 1166 occurs in two broad phases: a map phase 1150 and a reduce phase 1152. The map phase 1150 takes place across one or more search peers. In the map phase 1150, the search peers locate event data that matches the search terms in the search query 1166 and sorts the event data into field-value pairs. When the map phase 1150 is complete, the search peers send events that they have found to one or more search heads for the reduce phase 1152. During the reduce phase 1152, the search heads process the events through commands in the search query 1166 and aggregate the events to produce the final search results 1168.

A search head, such as the search head 1162 illustrated in FIG. 11, is a component of the search system 1160 that manages searches. The search head 1162, which may also be referred to herein as a search management component, can be implemented using program code that can be executed on a computing device. The program code for the search head 1162 can be stored on a non-transitory computer-readable medium and from this medium can be loaded or copied to the memory of a computing device. One or more hardware processors of the computing device can read the program code from the memory and execute the program code in order to implement the operations of the search head 1162.

Upon receiving the search query 1166, the search head 1162 directs the query 1166 to one or more search peers, such as the search peer 1164 illustrated in FIG. 11. “Search peer” is an alternate name for “indexer” and a search peer may be largely similar to the indexer described previously. The search peer 1164 may be referred to as a “peer node” when the search peer 1164 is part of an indexer cluster. The search peer 1164, which may also be referred to as a search execution component, can be implemented using program code that can be executed on a computing device. In some implementations, one set of program code implements both the search head 1162 and the search peer 1164 such that the search head 1162 and the search peer 1164 form one component. In some implementations, the search head 1162 is an independent piece of code that performs searching and no indexing functionality. In these implementations, the search head 1162 may be referred to as a dedicated search head.

The search head 1162 may consider multiple criteria when determining whether to send the query 1166 to the particular search peer 1164. For example, the search system 1160 may be configured to include multiple search peers that each have duplicative copies of at least some of the event data. In this example, the sending of search query 1166 to more than one search peer allows the search system 1160 to distribute the search workload across different hardware resources. As another example, search system 1160 may include different search peers for different purposes (e.g., one has an index storing a first type of data or from a first data source while a second has an index storing a second type of data or from a second data source). In this example, the search query 1166 may specify which indexes to search, and the search head 1162 will send the query 1166 to the search peers that have those indexes.

To identify events 1178 to send back to the search head 1162, the search peer 1164 performs a map process 1170 to obtain event data 1174 from the index 1138 that is maintained by the search peer 1164. During the first phase of the map process 1170, the search peer 1164 identifies buckets that have events that are described by the time indicator in the search query 1166. As noted above, a bucket contains events whose timestamps fall within a particular range of time. For each bucket 1144 whose events can be described by the time indicator, during a second phase of the map process 1170, the search peer 1164 performs a keyword search 1172 using search terms specified in the search query 1166. The search terms can be one or more of keywords, phrases, fields, Boolean expressions, and/or comparison expressions that in combination describe events being searched for. When segmentation is enabled at index time, the search peer 1164 performs the keyword search 1172 on the bucket's index file 1146. As noted previously, the index file 1146 includes a lexicon of the searchable terms in the events stored in the bucket's raw data 1148 file. The keyword search 1172 searches the lexicon for searchable terms that correspond to one or more of the search terms in the query 1166. As also noted above, the lexicon includes, for each searchable term, a reference to each location in the raw data 1148 file where the searchable term can be found. Thus, when the keyword search identifies a searchable term in the index file 1146 that matches query 1166, the search peer 1164 can use the location references to extract from the raw data 1148 file the event data 1174 for each event that includes the searchable term.

In cases where segmentation was disabled at index time, the search peer 1164 performs the keyword search 1172 directly on the raw data 1148 file. To search the raw data 1148, the search peer 1164 may identify searchable segments in events in a similar manner as when the data was indexed. Thus, depending on how the search peer 1164 is configured, the search peer 1164 may look at event fields and/or parts of event fields to determine whether an event matches the query 1166. Any matching events can be added to the event data 1174 read from the raw data 1148 file. The search peer 1164 can further be configured to enable segmentation at search time, so that searching of the index 1138 causes the search peer 1164 to build a lexicon in the index file 1146.

The event data 1174 obtained from the raw data 1148 file includes the full text of each event found by the keyword search 1172. During a third phase of the map process 1170, the search peer 1164 performs event processing 1176 on the event data 1174, with the steps performed being determined by the configuration of the search peer 1164 and/or commands in the search query 1166. For example, the search peer 1164 can be configured to perform field discovery and field extraction. Field discovery is a process by which the search peer 1164 identifies and extracts key-value pairs from the events in the event data 1174. The search peer 1164 can, for example, be configured to automatically extract the first one-hundred fields (or another number of fields) in the event data 1174 that can be identified as key-value pairs. As another example, the search peer 1164 can extract any fields explicitly mentioned in the search query 1166. The search peer 1164 can, alternatively or additionally, be configured with particular field extractions to perform.

Other examples of steps that can be performed during event processing 1176 include: field aliasing (assigning an alternate name to a field); addition of fields from lookups (adding fields from an external source to events based on existing field values in the events); associating event types with events; source type renaming (changing the name of the source type associated with particular events); and tagging (adding one or more strings of text, or a “tags” to particular events), among other examples.

The search peer 1164 sends processed events 1178 to the search head 1162, which performs a reduce process 1180. The reduce process 1180 potentially receives events from multiple search peers and performs various results processing 1182 steps on the events. The results processing 1182 steps can include, for example, aggregating the events from different search peers into a single set of events, deduplicating and aggregating fields discovered by different search peers, counting the number of events found, and sorting the events by timestamp (e.g., newest first or oldest first), among other examples. Results processing 1182 can further include applying commands from the search query 1166 to the events. The query 1166 can include, for example, commands for evaluating and/or manipulating fields (e.g., to generate new fields from existing fields or parse fields that have more than one value). As another example, the query 1166 can include commands for calculating statistics over the events, such as counts of the occurrences of fields, or sums, averages, ranges, and so on, of field values. As another example, the query 1166 can include commands for generating statistical values for purposes of generating charts of graphs of the events.

Through results processing 1182, the reduce process 1180 produces the events found by processing the search query 1166, as well as some information about the events, which the search head 1162 outputs to the search and reporting app 1116 as search results 1168. The search and reporting app 1116 can generate visual interfaces for viewing the search results 1168. The search and reporting app 1116 can, for example, output visual interfaces for the network access application 1106 running on a computing device 1104 to generate.

The visual interfaces can include various visualizations of the search results 1168, such as tables, line or area charts, Choropleth maps, or single values. The search and reporting app 1116 can organize the visualizations into a dashboard, where the dashboard includes a panel for each visualization. A dashboard can thus include, for example, a panel listing the raw event data for the events in the search results 1168, a panel listing fields extracted at index time and/or found through field discovery along with statistics for those fields, and/or a timeline chart indicating how many events occurred at specific points in time (as indicated by the timestamps associated with each event). In various implementations, the search and reporting app 1116 can provide one or more default dashboards. Alternatively, or additionally, the search and reporting app 1116 can include functionality that enables a user to configure custom dashboards.

The search and reporting app 1116 can also enable further investigation into the events in the search results. The process of further investigation may be referred to as drilldown. For example, a visualization in a dashboard can include interactive elements, which, when selected, provide options for finding out more about the data being displayed by the interactive elements. To find out more, an interactive element can, for example, generate a new search that includes some of the data being displayed by the interactive element, and thus may be more focused than the initial search query 1166. As another example, an interactive element can launch a different dashboard whose panels include more detailed information about the data that is displayed by the interactive element. Other examples of actions that can be performed by interactive elements in a dashboard include opening a link, playing an audio or video file, or launching another application, among other examples.

Various examples and possible implementations have been described above, which recite certain features and/or functions. Although these examples and implementations have been described in language specific to structural features and/or functions, it is understood that the subject matter defined in the appended claims is not necessarily limited to the specific features or functions described above. Rather, the specific features and functions described above are disclosed as examples of implementing the claims, and other equivalent features and acts are intended to be within the scope of the claims. Further, any or all of the features and functions described above can be combined with each other, except to the extent it may be otherwise stated above or to the extent that any such examples may be incompatible by virtue of their function or structure, as will be apparent to persons of ordinary skill in the art. Unless contrary to physical possibility, it is envisioned that (i) the methods/steps described herein may be performed in any sequence and/or in any combination or sub-combination, and (ii) the components of respective examples may be combined in any manner.

Processing of the various components of systems illustrated herein can be distributed across multiple machines, networks, and other computing resources. Two or more components of a system can be combined into fewer components. Various components of the illustrated systems can be implemented in one or more virtual machines or an isolated execution environment, rather than in dedicated computer hardware systems and/or computing devices. Likewise, the data repositories shown can represent physical and/or logical data storage, including, e.g., storage area networks or other distributed storage systems. Moreover, in some examples the connections between the components shown represent possible paths of data flow, rather than actual connections between hardware. While some examples of possible connections are shown, any of the subset of the components shown can communicate with any other subset of components in various implementations.

Examples have been described with reference to flow chart illustrations and/or block diagrams of methods, apparatus (systems), and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

In the Figures, bracketed text and blocks with dashed borders (e.g., large dashes, small dashes, dot-dash, and dots) may be used herein to illustrate optional aspects that add additional features to some examples. However, such notation should not be taken to mean that these are the only options or optional operations, and/or that blocks with solid borders are not optional in certain examples.

Reference numerals with suffix letters may be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

In the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

Additionally, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted in an open-ended manner to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

In some examples, certain operations, acts, events, or functions of any of the algorithms described herein can be performed in a different sequence, can be added, merged, or left out altogether (e.g., not all are necessary for the practice of the algorithms). In certain examples, operations, acts, functions, or events can be performed concurrently, e.g., through multi-threaded processing, interrupt processing, or multiple processors or processor cores or on other parallel architectures, rather than sequentially.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method comprising:
obtaining, by an attack surface management system implemented by one or more computing devices, a collection of attack surface metadata associated with computing resources in one or more information technology (IT) environments;
receiving, at the attack surface management system, a user-specified tag specification, the tag specification identifying a name for the tag and a logical criterion to be evaluated to determine whether the tag is to be associated with a target computing resource;
evaluating the tag specification, by the attack surface management system, based on the logical criterion and the collection of attack surface metadata, to identify a first computing resource of the computing resources;
associating the tag with the first computing resource in a data structure; and
causing a user interface to be displayed indicating that the first computing resource is associated with the tag.

2. The computer-implemented method of claim 1, wherein the user-specified tag specification further includes a priority value indicative of when to process the tag specification relative to other tag specifications.

3. The computer-implemented method of claim 1, wherein the user-specified tag specification further includes a risk value indicative of a risk severity associated with the tag that is applied to an associated computing resource.

4. The computer-implemented method of claim 1, wherein the user-specified tag specification further includes identifiers of one or more associated tags that are also to be associated with a target computing resource upon the logical criterion being satisfied for that target computing resource, wherein the method further comprises:
associating the one or more associated tags with the first computing resource in the data structure,
wherein the user interface further indicates that the one or more associated tags are also associated with the first computing resource.

5. The computer-implemented method of claim 1, wherein the user-specified tag specification further includes one or more uniform resource location (URL) path values, and wherein the method further comprises:
gathering additional attack surface metadata, comprising transmitting requests via use of the one or more URL path values.

6. The computer-implemented method of claim 5, further comprising:
evaluating a second user-specified tag specification, after the evaluating of the tag specification, based on use of the additional attack surface metadata.

7. The computer-implemented method of claim 6, wherein:
the tag specification includes a first priority value;
the second tag specification includes a second priority value that is different than the first priority value; and
the second user-specified tag specification is evaluated after the tag specification based on the second priority value being larger or smaller than the first priority value.

8. The computer-implemented method of claim 1, wherein the user-specified tag specification further includes identifiers of one or more known targets, and wherein the method further comprises:
determining that the user-specified tag specification, based on the logical criterion, does match each of the one or more known targets; and
enabling the tag specification for use within the attack surface management system.

9. The computer-implemented method of claim 1, wherein the user-specified tag specification further includes identifiers of one or more known non-targets, and wherein the method further comprises:
determining that the user-specified tag specification, based on the logical criterion, does not match each of the one or more known non-targets; and
enabling the tag specification for use within the attack surface management system.

10. The computer-implemented method of claim 1, wherein the logical criterion includes use of a regular expression or a logical comparison operator.

11. The computer-implemented method of claim 1, further comprising executing a user-selected action, associated with the user-specified tag specification, based on the identification of the first computing resource.

12. The computer-implemented method of claim 1, wherein the tag specification is provided in a human-readable data serialization language.

13. The computer-implemented method of claim 1, further comprising:
receiving a second tag specification, wherein the second tag specification identifies a second tag but does not include any condition;
evaluating the second tag specification prior to the evaluating of the tag specification, wherein the tag specification further includes an identifier of the second tag as being an associated tag for the tag specification; and
after the evaluating of the tag specification, associating the second tag with the first computing resource in the data structure.

14. The computer-implemented method of claim 1, wherein the receiving of the user-specified tag specification comprises receiving a pull request, and wherein the method further comprises:
presenting the tag specification via a second user interface to a second user; and
receiving a request originated on behalf of the second user to merge the user-specified tag specification into a collection of tag specifications utilized by the attack surface management system.

15. A non-transitory computer-readable medium having stored thereon instructions which, when executed by one or more processors of one or more computing devices, cause the one or more computing devices to implement an attack surface management system to perform operations comprising:
obtaining a collection of attack surface metadata associated with computing resources in one or more information technology (IT) environments;
receiving a user-specified tag specification, the tag specification identifying a name for the tag and a logical criterion to be evaluated to determine whether the tag is to be associated with a target computing resource;
evaluating the tag specification, based on the logical criterion and the collection of attack surface metadata, to identify a first computing resource of the computing resources;
associating the tag with the first computing resource in a data structure; and
causing a user interface to be displayed indicating that the first computing resource is associated with the tag.

16. The non-transitory computer-readable medium of claim 15, wherein the user-specified tag specification further includes identifiers of one or more associated tags that are also to be associated with a target computing resource upon the logical criterion being satisfied for that target computing resource, wherein the operations further comprise:
associating the one or more associated tags with the first computing resource in the data structure,
wherein the user interface further indicates that the one or more associated tags are also associated with the first computing resource.

17. The non-transitory computer-readable medium of claim 15, wherein the operations further comprise:
receiving a second tag specification, wherein the second tag specification identifies a second tag but does not include any logical criterion;
evaluating the second tag specification prior to the evaluating of the tag specification, wherein the tag specification further includes an identifier of the second tag as being an associated tag for the tag specification; and
after the evaluating of the tag specification, associating the second tag with the first computing resource in the data structure.

18. A system comprising:
a first one or more computing devices to implement a data store providing one or more repositories, the data store to store at least a collection of attack surface metadata associated with computing resources in one or more information technology (IT) environments; and
a second one or more computing devices to implement an attack surface management system, the attack surface management system including instructions which when executed by one or more processors of the second one or more computing devices, cause the attack surface management system to:
access, via the first one or more computing devices, the collection of attack surface metadata associated with computing resources in the one or more IT environments;
receive a user-specified tag specification, the tag specification identifying a name for the tag and a logical criterion to be evaluated to determine whether the tag is to be associated with a target computing resource;
evaluate the tag specification, based on the logical criterion and the collection of attack surface metadata, to identify a first computing resource of the computing resources;
associate the tag with the first computing resource in a data structure, wherein the data structure is stored in the one or more repositories; and
cause a user interface to be displayed indicating that the first computing resource is associated with the tag.

19. The system of claim 18, wherein the user-specified tag specification further includes identifiers of one or more associated tags that are also to be associated with a target computing resource upon the logical criterion being satisfied for that target computing resource, wherein the instructions, when executed, further cause the attack surface management system to:
associate the one or more associated tags with the first computing resource in the data structure,
wherein the user interface further indicates that the one or more associated tags are also associated with the first computing resource.

20. The system of claim 18, wherein the instructions, when executed, further cause the attack surface management system to:
receive a second tag specification, wherein the second tag specification identifies a second tag but does not include any logical criterion;
evaluate the second tag specification prior to the evaluating of the tag specification, wherein the tag specification further includes an identifier of the second tag as being an associated tag for the tag specification; and
after the evaluation of the tag specification, associate the second tag with the first computing resource in the data structure.
